(19) United States
(12) Patent Application Publication
(10) Pub. No.: US 2009/0112535 A1
(43) Pub. Date: Apr. 30, 2009

(54) METHOD OF INTEGRATING POINT MASS EQUATIONS TO INCLUDE VERTICAL AND HORIZONTAL PROFILES

(75) Inventor: James D. PHILLIPS, Boulder Creek, CA (US)

Correspondence Address: BURR & BROWN, PO BOX 7068, SYRACUSE, NY, 13261-7068, US

(73) Assignee: Sensis Corporation, East Syracuse, NY (US)

(21) Appl. No.: 12/146,857

(22) Filed: Jun. 26, 2008

Related U.S. Application Data
(60) Provisional application No. 60/982,855, filed on Oct. 26, 2007.

(51) Int. Cl. G06G 7/72; G06F 17/10

(52) U.S. Cl. 703/2

(57) ABSTRACT

The present invention provides a system and method for simulating aircraft flight path trajectory by integrating the point mass equations using a selectable non-time based integration variable, including altitude, velocity or range. The present invention separates the horizontal and vertical profiles of an aircraft's flight path trajectory. The horizontal profile is specified as a series of waypoints, defined by latitude-longitude pairs and the vertical profile is specified as an initial state and a list of segment types, defined by altitude and velocity, and end states. The altitude-velocity segment types are continuous, such that the end state of one segment is the starting point of the following segment. The point mass equations and the non-time based integration variables are iteratively integrated to merge the horizontal and vertical profiles of a flight path trajectory. The present invention provides improved aircraft position accuracy and the use of a non-time based integration variable enables greater simulation efficiency.

### CROSS REFERENCE TO RELATED APPLICATION

This application claims the benefit of U.S. Provisional Application Ser. No. 60/982,855 filed Oct. 26, 2007 (entitled Method of Integrating Point Mass Equations to Merge Vertical and Horizontal Profiles, Attorney Docket No. 881_{—}050 PRO), the entirety of which is incorporated herein by reference.

### FIELD OF THE INVENTION

The present invention relates to a method and system for efficiently simulating the flight path trajectory of at least one aircraft within a predetermined airspace using a non-timed based integration variable. As a result, the present invention can efficiently simulate the flight path trajectory for the current volume of aircraft flights within a predetermined airspace, and the anticipated growth in flight volume over the next quarter century.

### BACKGROUND OF THE INVENTION

The management of airspace and airport terminal operations has always been a daunting task due to the amount of aircraft traffic especially in and around an airport. As international commerce has grown over the years, so has the amount of traffic passing through virtually every airport around the world. Currently, there are between 60,000 and 80,000 scheduled commercial flights in U.S. National Airspace (NAS) alone. Industry experts are currently predicting global air travel demand to grow by an estimated 5.2% annually and result in nearly a three-fold increase in the number of flights compared to current traffic levels over the next twenty years. The continued growth of air traffic will generate additional demand for operations in the vicinity of airports and on the airport surface. This increased demand will require a significant and continuous investment in the air traffic infrastructure simply to meet the increasing demand while trying to maintain current safety levels. However, maintaining current safety levels runs counter to the aviation industry's goal of improving safety while reducing operational costs, year after year.

As additional commercial flights and aircraft are added to handle the predicted growth, greater congestion and delays, as well as inefficient aircraft routing resulting in greater fuel consumption and a reduction in flight safety will likely result without adequate airspace management infrastructure planning and development. The infrastructure planning and development requirements for airspace management, including the airports and terminal control areas, involve all facets of aviation, and the solution needs to be based upon three underlying principles; improved safety, improved capacity and cost effectiveness.

To determine the effectiveness of various strategies for developing the airspace management infrastructure, modeling and/or simulation tools are a cost effective method for determining constraints, such as bottlenecks, and the effect of proposed strategies for upgrading the existing airspace management infrastructure. More specifically, an aircraft trajectory simulation can be used to model the current and predicted air traffic in a predetermined area, such as the NAS, to identify capacity constraints and assess the effectiveness of potential solutions on flight volume throughput in a cost effective manner.

Current aircraft trajectory simulation tools are time integration based, meaning that the simulation performs the necessary calculations based on each change or increment in the time domain. The time increments are typically set to a single value for the duration of the simulation. Due to the computational requirements, these current aircraft trajectory simulation tools are limited in data throughput rates (i.e., number of simulated aircraft) that can be achieved.

Commercial airlines currently use aircraft trajectory simulation tools to simulate the flights scheduled for the next day to determine the most efficient routings and estimate fuel consumption, as well as estimate the arrival times for their flights, based on the anticipated meteorological conditions. For example, the Eurocontrol model, BADA, is primarily a simple aerodynamic and propulsion model by aircraft type and does not provide a way to directly determine the aircraft's position as a function of time.

In addition, current aircraft trajectory simulation tools can simulate approximately one flight path trajectory per second and simulations are frequently integrated 3 or 4 times to account for changes necessary based on the results of the simulation run. Therefore, using current aircraft trajectory simulation tools the flight schedule of a single airline having roughly 10,000 scheduled flights for the following day requires approximately 3 hours per simulation run and a single simulation run for the approximately 120,000 flights per day in the NAS requires about 12 hours running on two high-end desktop computers. Obviously, performing multiple simulation runs daily for the expected 180,000+flights per day in the NAS would be extremely difficult using existing simulation tools.

Thus, what is needed is a system and method for efficiently simulating aircraft flight trajectories, for both current and predicted future air traffic volume, within a predetermined airspace, such as the NAS, for airspace management planning and infrastructure development.

### SUMMARY OF THE INVENTION

The present invention provides a method and system for simulating aircraft flight trajectories that meet the needs discussed above. One embodiment of the present invention provides a method of simulating the flight path trajectory of an aircraft between two fixed points which includes operating at least an aerodynamic model, a propulsion model for the aircraft type and a program including point mass equations on one or more linked computers, the method comprising the steps of:

defining the two fixed points as a point of origin and a destination, respectively, and defining a plurality of waypoints and a plurality of altitude-velocity segments between the two fixed points;

defining a time of takeoff, an aircraft empty weight and gross weight at the point of origin; wherein the aerodynamic model and the propulsion model determine the performance characteristics of said aircraft;

determining the aircraft flight path trajectory using the program including the point mass equations, wherein the program including the point mass equations separates the aircraft flight path trajectory into a horizontal profile and a vertical profile;

selecting a non-time based integration variable and a step size for the non-time based integration variable for each altitude-velocity segment of the vertical profile;

integrating the horizontal profile and the vertical profile of the aircraft flight path trajectory iteratively at least at each node along the flight path trajectory using the program including point mass equations and the selected non-time based integration variables.

The flight path trajectory includes at least a climbing phase, an en route phase and a descent phase of flight. The method of simulating the flight path trajectory further includes at least one of the step of determining the environmental conditions along the flight path trajectory, and the step of displaying the simulated flight path trajectory to a user on a monitor.

The aircraft performance characteristics must include aircraft weight, lift, drag, engine fuel burn and thrust characteristics of the aircraft. These aircraft performance characteristics can be based on very simple models. The aircraft performance characteristics can also include climb speed, descent speed, cruise speed, payload and fuel load for the aircraft. The environmental conditions include at least one of winds aloft and temperatures along the flight path trajectory.

In a preferred embodiment, the horizontal profile includes waypoints, which are geographic locations defined by a latitude-longitude pair, and the waypoints are connected to each other using a combination of great circle arcs and small circle arcs along the flight path. The simplest trajectory would be a route including only an origin and a destination with a vertical profile of a single segment. Preferably, the vertical profile includes at least a starting node and an ending node along the aircraft flight path trajectory and an altitude-velocity segment type. The altitude-velocity segments preferably include at least one acceleration, deceleration or cruise speed of the aircraft. The non-time based integration variable is one of altitude, velocity, range or flight path angle for each altitude-velocity segment, but may also include other variables, including turn angle for turns and time for loitering.

In one embodiment of the present invention, the non-time based integration variable is altitude during the climb and descent phases of flight and the non-time based integration variable is range during en route phase of flight. In another embodiment, the non-time based integration variable is velocity during the climb and descent phases of flight and the non-time based integration variable is range during en route phase of flight. Preferably, for multiple altitude-velocity segments of the flight path trajectory, each segment can be integrated using a different non-time based integration variable. The trajectory is completely specified by the segment type and the end condition, for example, a climb at constant indicated airspeed to 10,000 feet. There are no further degrees of freedom to satisfy any additional constraints on the altitude-velocity segment. Where FAR flight restrictions are applicable, the altitude-velocity segment type and end point must be specified to satisfy the applicable FAR flight restriction.

In one embodiment of the present invention, the method also includes the steps of: receiving a change to the flight path trajectory; determining a new flight path trajectory using the program including point mass equations and at least one selected non-time based integration variable, and integrating the horizontal profile and the vertical profile iteratively at points along the new flight path trajectory using the program including point mass equations and the at least one selected non-time based integration variable. The non-time based integration step size can be varied based on variables including aircraft maneuvers. For example, each altitude-velocity segment has an argument for the turn step size, which will automatically be used if a turn occurs during the altitude-velocity segment.

In another embodiment, the method of the present invention includes the step of storing the simulated flight path trajectory of the aircraft on a computer readable medium. In a preferred embodiment, the method includes the step of validating the stored simulated aircraft flight path trajectory with actual flight path trajectory data for the aircraft.

Another embodiment of the present invention provides a system for simulating the flight path trajectory of an aircraft, including at least one computer, the system comprising:

means for defining a point of origin and a destination, a time of takeoff, aircraft empty weight and gross weight at a point of origin, and a plurality of waypoints and a plurality of altitude-velocity segments between the point of origin and the destination;

means for determining performance characteristics of the aircraft;

means for determining the flight path trajectory of the aircraft, wherein the means for determining the aircraft flight path trajectory separates the flight path trajectory into a horizontal profile and a vertical profile for the aircraft;

means for selecting an appropriate non-time based integration variable and an integration variable step size for each of the one or more segments in the vertical profile; and

means for integrating the horizontal profile and the vertical profile iteratively at least at each node along the flight path trajectory using the selected non-time based integration variable.

In one embodiment of the present invention, the means for determining the flight path trajectory comprises a program on computer readable medium. The flight path trajectory includes at least one of a climbing phase, an en route phase and a descent phase of flight. In another embodiment, the system includes at least one of means for determining environmental conditions along the flight path trajectory and means for displaying the simulated flight path trajectory to a user on a monitor.

The aircraft performance characteristics must include aircraft weight, lift, drag, engine fuel burn and thrust characteristics of the aircraft. These aircraft performance characteristics can be based on very simple models. The aircraft performance characteristics can also include climb speed, descent speed, cruise speed, payload and fuel load for the aircraft. The environmental conditions include at least one of winds aloft and temperatures along the flight path trajectory.

In a preferred embodiment, the horizontal profile includes waypoints, which are geographic locations defined by a latitude-longitude pair, and the waypoints are connected to each other using a combination of great circle arcs and small circle arcs along the flight path. Preferably, the vertical profile includes at least a starting node and an ending node along the aircraft flight path trajectory and an altitude-velocity segment type. The altitude-velocity segments preferably include at least one acceleration, deceleration or cruise speed of the aircraft. The non-time based integration variable is one of altitude, velocity, range or flight path angle for each altitude-velocity segment.

In one embodiment of the present invention, the non-time based integration variable is altitude during the climb and descent phases of flight and the non-time based integration variable is range during en route phase of flight. In another embodiment, the non-time based integration variable is velocity during the climb and descent phases of flight and the non-time based integration variable is range during en route phase of flight. Preferably, different non-time based integration variables are used to integrate one or more altitude-velocity segments of the flight path trajectory. Where FAR flight restrictions are applicable, the altitude-velocity segment type and end point must be specified to satisfy the applicable FAR flight restriction.

In one embodiment, the system further includes: means for receiving a change to the flight path trajectory; means for determining a new flight path trajectory using at least one selected non-time based integration variable, and means for integrating the horizontal profile and the vertical profile iteratively at points along the new flight path trajectory using at least one selected non-time based integration variable. The non-time based integration step size can be varied based on variables including aircraft maneuvers. For example, each altitude-velocity segment has an argument for the turn step size, which will automatically be used if a turn occurs during the altitude-velocity segment.

In another embodiment, the system further includes means for storing the simulated flight path trajectory on a computer readable medium. In a preferred embodiment, the system includes means for validating the simulated aircraft flight path trajectory stored on a computer readable medium against actual flight path trajectory data.

The flexible and robust design of the trajectory simulation software of the present invention enables the present invention to be integrated with other existing or proposed support systems and tools, including decision support tools, conceptual design and trajectory optimization software packages.

### BRIEF DESCRIPTION OF THE DRAWINGS

For a fuller understanding of the nature and objects of the invention, reference should be made to the following detailed description of a preferred mode of practicing the invention, read in connection with the accompanying drawings in which:

FIG. 1 shows the horizontal and separate vertical profiles in the simulated flight path trajectory of the present invention;

FIG. 2 depicts the data inputs, computations and data outputs of a first embodiment of the present invention;

FIG. 3 depicts the data inputs, computations and data outputs of a second embodiment of the present invention;

FIG. 4 shows how vertical profile segments are defined in energy space using one or more non-time based integration variables;

FIG. 5 depicts the change in the step size of the non-time based integration variable for turns;

FIG. 6 depicts the point mass diagram for an aircraft in flight;

FIG. 7 shows the interpolation of aircraft flight path trajectory between nodes;

FIG. 8 depicts simulated flight path trajectory error from discrete time-based changes;

FIG. 9 depicts the point mass wind triangle; and

FIG. 10 shows a controlled descent phase of flight to destination.

### DETAILED DESCRIPTION OF THE INVENTION

The system and method of the present invention simulates one or more aircraft flight path trajectories that consist of one or more waypoints and altitude-velocity segments between two fixed points using the point mass equations for an aircraft. In one embodiment of the system and method of present invention, the system comprises software programs running on a single computer or multiple linked computers. The software program can be stored on a computer readable medium or can be resident on an external drive of the computer system.

In some existing methods for simulating the flight path trajectory of an aircraft, the simulation scheme attaches vertical constraints either to individual flight paths segments between waypoints or to the waypoints. The problem associated with attaching vertical constraints to a horizontal segment is that it couples a speed or altitude specification to a horizontal segment before the simulation determines the appropriate horizontal segment for applying the vertical constraint. Thus, the use of vertical constraints in these simulation methods results in two aircraft with different performance characteristics, having completely different specifications for the same flight path trajectory. In addition, the trajectory of the aircraft would have to be estimated or integrated in order to specify the vertical profile (i.e., vertical constraints) correctly in these simulation methods. Further, during integration of actual vertical profile data for the aircraft, these simulation methods may determine that the vertical profile was incorrectly specified, thereby requiring another complete iteration of the flight path trajectory for the aircraft. Thus, not only does the inclusion of vertical constraints in these simulation methods introduce a source of error, it also significantly increases the computations required for simulating the flight path trajectory of an aircraft, thereby limiting the number of aircraft flight path trajectories that can be simulated in a fixed period of time.

In contrast, by separating the horizontal profile and the vertical profile of the flight path trajectory and integrating the point mass equilibrium equations using the selected non-time based integration variables, the point mass trajectory function of the present invention determines the turn points in the flight path trajectory as the flight path trajectory is integrated and effectively merges the vertical and horizontal profiles at each turn point. Thus, the present invention eliminates the errors associated with attaching vertical constraints to a horizontal segment and reduces the number of required computations for simulating a flight path trajectory, thereby increasing the number of flight path trajectories that can be simulated in a fixed period of time. The vertical profile and horizontal profile can also be intentionally joined using controlled throttle segments. The integration of the point mass equilibrium equations is discussed in subsequent sections of the specification.

The system and method of simulating flight path trajectory according to the present invention is advantageous because the point mass trajectory function provides a very accurate trajectory and does not use small angle approximations (see Point Mass Equation Calculation Sample), while reducing the computations required to simulate a flight path trajectory. The reduction in computational requirements enables the computer to process a significantly greater number of simulated aircraft flight path trajectories than can be performed by existing aircraft flight path trajectory simulations in a defined period of time. For example, the Multi-Purpose Aircraft Simulation (MPAS) program can simulate approximately one aircraft trajectory per second, enabling MPAS to simulate 10,000 flights in approximately three hours. In contrast, the flight path trajectory simulation system and method of the present invention running on 2.8 GHz desktop computer with 1.5 GB of RAM can simulate from twenty to eighty trajectories per second, enabling the present invention to simulate 10,000 flights in 8 minutes or less.

One of the key concepts of the present invention is the separation of the horizontal flight profile and the vertical flight profile. The separation of the simulated flight path trajectory for the aircraft into horizontal and vertical flight profiles enables the horizontal profile to be specified as a list of waypoints (latitude-longitude pairs) connected by great circle arcs between the waypoints and small circle arcs for turns. This horizontal profile flight path is continuous and one-dimensional. For example, a single coordinate, range, uniquely specifies each position on the horizontal profile flight path. The simulated flight path trajectory does not deviate from the prescribed horizontal profile flight path.

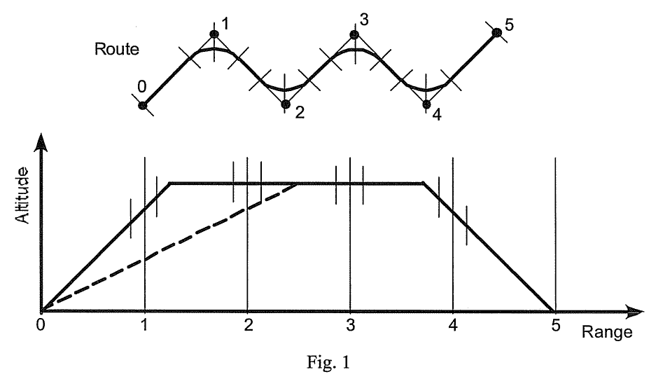

FIG. 1 shows a schematic of a vertical profile and horizontal profile for a flight path trajectory. The aircraft flight path trajectory shown in FIG. 1 is a simple flight profile depicting three phases of flight, a climbing phase to reach the assigned altitude, followed by an en route or cruise phase at the assigned altitude, and then a descent phase to reach the final destination. For example, an altitude and latitude-longitude pair can define the final destination.

### System Components

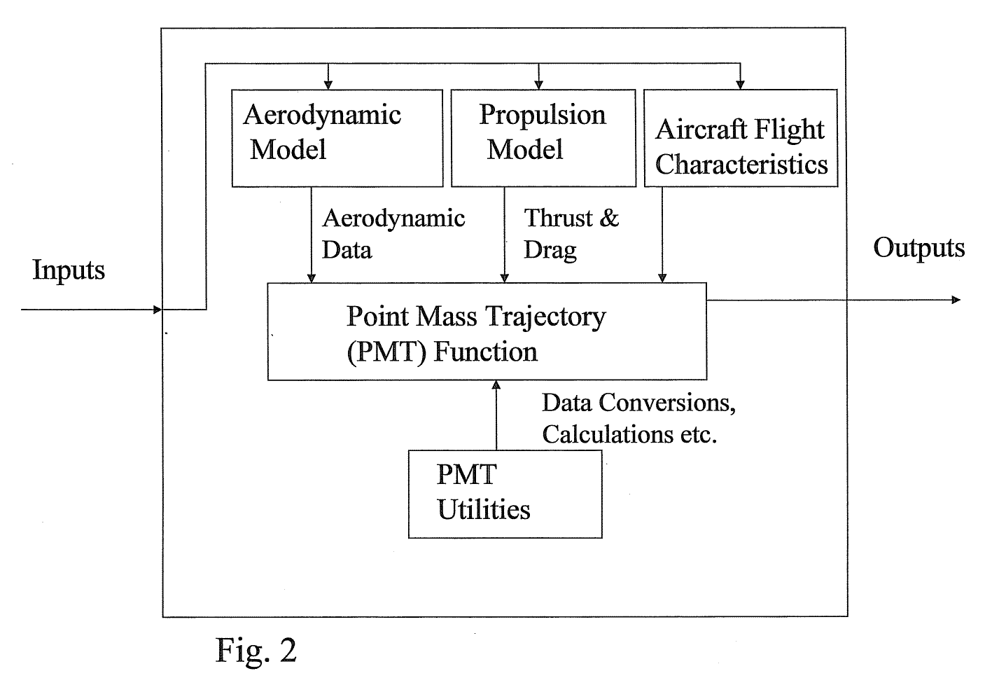

The system and method of present invention includes one or more software programs running on a single computer or multiple linked computers. The software programs of the present invention include an aerodynamic model, a propulsion model and the point mass trajectory function and point mass trajectory utilities running on a computer system. The minimum requirements for the computer processor are a central processor running at 800 MHz with a minimum of 1 GB of RAM and 40 GB of disk space. The aerodynamic model and propulsion model can be included in the computer system running the point mass trajectory function, as shown in FIG. 2, or can be resident on separate computer platforms that are capable of transmitting and receiving data at rates sufficient to support the present invention. The amount of data being transferred is dependent on the number of aircraft flight path trajectories being simulated and the complexity of the flight path trajectories being simulated. The present invention includes aerodynamic models and propulsion models for several different types of aircraft and propulsion systems, respectively.

The first embodiment of the present invention can construct a simulated flight path trajectory for an aircraft using only data that is typically available in an aircraft's flight plan, as shown in FIG. 2. In the first embodiment, the input data includes the aircraft type, aircraft weight data, an initial altitude, a list of waypoints, an en route cruise altitude and airspeed and a destination (final) altitude. Where applicable, the input data may also include departure and arrival taxi points and any external configuration changes to the aircraft that may affect the drag and thrust calculations for an aircraft.

In this embodiment, the inputs to the aerodynamic and propulsion model are angle of attack (AOA), altitude, airspeed and aircraft configuration, as shown in FIG. 2. Additionally, throttle setting is an input to the propulsion model. The aerodynamic model uses the input data to compute aerodynamic data including aircraft lift, drag and trim angle. The propulsion model uses the input data to compute the thrust and fuel flow for the aircraft. The data calculated by the aerodynamic model and propulsion model are inputs used extensively in the point mass trajectory function.

The combination of the aerodynamic model and propulsion model may determine specific flight characteristics of the aircraft including calculated airspeeds (CAS) and Mach numbers for the climb and descent phases of flight, takeoff and landing stall speeds of the aircraft and maximum operating speed (VMO) for the aircraft. Alternatively, the flight characteristics may be determined by a table look up or interpolation between table look up values stored in computer system memory.

The point mass trajectory function includes a set of utility programs (i.e., utilities) that perform one or more of the following functions: data conversion including measured units and speed values, and mathematical calculations including vectors and wind triangles, as well as calculations for an intelligent step size. The intelligent step size function enables the designated step in altitude to be positioned at an even number or a rounded off number instead of an exact altitude based on the initial altitude. For example, if the initial altitude is 732 feet and the specified step size is 500 feet, the intelligent step size function will assign the first step to an altitude of 1000 feet instead of 1232 feet. This enables the present invention to perform updates at similar altitudes for the flight path trajectories of different aircraft.

The utilities also include a zero finding function that is used in solving the point mass equations. The utilities may also include physical constants (e.g., gravity and the radius of the earth) and data pre-processing that limits the range of values that can be input into the present invention.

From the input data and the data output from the aerodynamic model and propulsion model, the point mass trajectory function determines a simulated flight path trajectory for the aircraft that includes a horizontal profile and a vertical profile. The output of the simulated aircraft flight path trajectory of the present invention includes the aircraft trajectory state as a function of sampled time. The aircraft trajectory state includes: aircraft weight, position (latitude and longitude), altitude, true airspeed, heading, flight path angle, bank angle, angle of attack (AOA), range (i.e., integrated distance), time, climb rate, ground speed and true course.

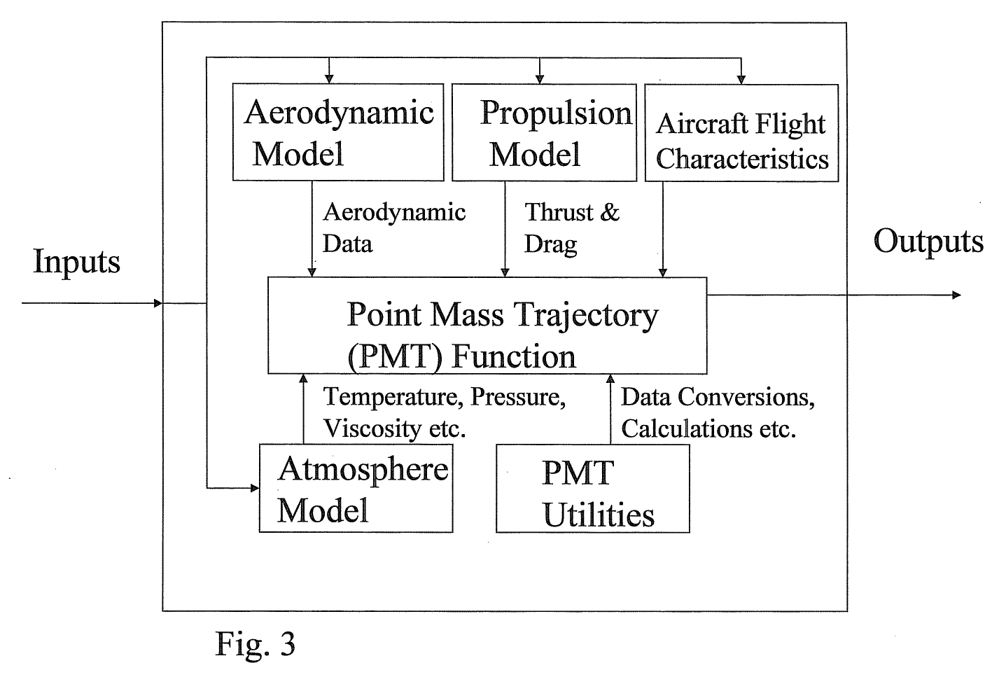

In a second embodiment of the present invention, which includes an atmosphere model, the input data may include winds aloft speed and direction and temperature increment above standard data, as shown in FIG. 3. The atmosphere model includes 4D winds and 4D temperature increment above standard. The atmosphere model is a utility that is used as an input to the point mass function. The data from the atmosphere model provides at least one of temperature, pressure, viscosity, density, and speed of sound values for the specific atmospheric conditions. The data calculated by the atmosphere model are used by the point mass trajectory function in specifying the trajectory, calculating CAS and Mach, for example. The atmosphere model outputs are also used in the calculations performed by the aerodynamic and propulsion model For example; the propulsion model uses the temperature increment above standard data to determine available thrust. In embodiments of the present invention that do not include an atmosphere model, the present invention uses default values of no wind and standard temperature. The winds aloft are also used to solve the wind triangle, which is discussed later in the specification.

The system and method of present invention can output the simulated flight path trajectory for the aircraft to a display apparatus, such as a monitor, for display to the user. This enables the user to review the simulated flight path trajectory and change the flight path, as necessary.

The simulated flight path trajectory for an aircraft output by the system and method of present invention can be stored on a computer readable medium or an external drive of the computer system. The stored simulated flight path trajectory for an aircraft output by the system and method of present invention can be compared to actual flight data for the aircraft and, thereby, validated.

### Horizontal Profile and Vertical Profile

The horizontal profile, shown in FIG. 1, is constructed as a list of waypoints (labeled 0 to 5) and includes great circle arcs, which define the shortest direct path between adjacent waypoints, and small circle arcs, which define the aircraft's turns required to intersect the next waypoint or great circle arc in the vicinity of a waypoint. Range is defined as the distance from the initial point of the simulated aircraft flight path trajectory along the horizontal profile including the distance along the turns. The range corresponding to the crossing of the waypoints is transferred to the vertical profile, shown in FIG. 1 as a plot of altitude verses range. The horizontal profile also includes turn radius and bank angles associated with applicable true airspeed shape functions.

The vertical profile of the flight path trajectory depicts the first turn, which commences prior to waypoint 1, occurring during the climbing phase of the flight and the last turn, ending after waypoint 4, occurring during the descent phase of the flight. As shown in FIG. 1, the aircraft will end the climbing phase of the flight (i.e., reach the top of the climb) and will begin the descent phase (i.e., top of descent) at locations that do not correspond to any of the waypoints. More specifically, the end of the climbing phase (i.e., top of climb) will occur between waypoints 1 and 2 and the start of the descent phase (i.e., top of descent) will occur between waypoints 3 and 4.

While the horizontal profile will be the same for all aircraft flying a particular flight path trajectory, even aircraft having significantly different performance characteristics, the vertical profile will vary significantly based on the different performance characteristics of the aircraft, as shown in FIG. 1. For example, if an aircraft flying having lower performance characteristics flies the flight path trajectory shown in FIG. 1, the vertical profile for the lower performance aircraft would follow the path depicted by the dashed line in FIG. 1. More specifically, the vertical profile of the lower performance aircraft would have turns 1 and 2 occurring during the climbing phase of the flight with the enroute phase starting between waypoints 2 and 3.

Some of the disadvantages of prior art simulations are highlighted by the following: if there was an altitude constraint that requires the aircraft to be at cruise altitude on the second segment in FIG. 1 (i.e., between points 1-2), the low performance aircraft would not be able to meet the cruise altitude constraint. In one prior art simulation, the lower performance aircraft would enter a spiral climb at the end of the segment in order to meet the vertical constraint because continuing on to the third segment without achieving the cruise altitude constraint might lead to a conflict with a vertical constraint on the third segment. Additionally, to specify the cruise altitude constraint on the correct horizontal segment, prior art simulations would have to perform an initial integration of the simulated flight path trajectory to determine that the top of descent for the low performance aircraft was on the third segment. Since this initial integration of the vertical profile neglects to account for the aircraft performance during turns, the result of this initial integration is only an approximation of the flight path trajectory. Any approximation risks specifying the wrong horizontal segment for an event. Thus, during integration of the actual vertical profile data for the aircraft, the simulation method may determine that the vertical profile was incorrectly specified, thereby requiring another complete iteration of the flight path trajectory for the aircraft.

From a simple flight path trajectory, as shown in FIG. 1, the present invention will typically create a vertical profile containing six to ten segments for the climb phase of flight, one to six segments for the en route phase of flight and five to ten segments for the descent phase of flight. The user ordinarily determines the segment type for each segment of the vertical profile. The segment type can also be determined by the point mass trajectory function. For example, a user could specify an entire vertical profile based on only the data in the flight plan. The present invention would use the performance characteristics for the aircraft type, including aerodynamic and propulsion models, to design a reasonable vertical profile for the simulated flight path trajectory.

The vertical profile is specified as an initial state and a list of segment types and end state for each segment. The segment types of the vertical profile define the path shape in energy space and are typically defined as an altitude (h) and a velocity (V). Typically, only one end-point coordinate (i.e., V or h) is specified for each altitude-velocity segment with the other coordinate determined by the starting point of the altitude-velocity segment and the segment type.

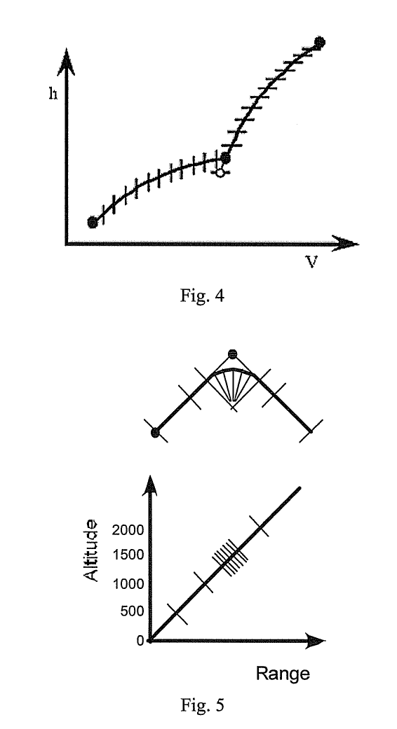

Trajectory analysis for the purpose of getting the fuel burn and time elapsed are sometimes allowed to be discontinuous to reduce the computations required. In the method of simulating an aircraft flight path trajectory of the present invention, the flight path trajectory is continuous, meaning that the end point of one segment also defines the starting point of the next segment, as shown in FIG. 4.

In the present invention, the vertical profile is integrated efficiently using variables that are non-time based. For example, FIG. 4 shows a vertical profile segment between the first two points that is integrated using velocity (V) as the non-time based integration variable, and a vertical segment between the second and third points that is integrated using altitude (h) as the non-time based integration variable.

In the system and method of the present invention, the step size and final value of each node is specified as a function of an appropriate non-time based integration parameter. Where the aircraft is climbing or descending, the natural non-time based integration parameter is altitude because the altitude of the aircraft is changing. In this case, velocity, for example, would be a poor choice for the non-time based integration parameter because velocity does not change in a constant true airspeed climb. The vertical profile segments are defined as constant energy segments, ground segments, controlled throttle segments and energy change segments, which includes energy trade segments. Constant energy segments include en route cruise segments. Ground segments include constant speed taxi segments and ground roll segments. Controlled throttle segments include controlled energy trade segments and constant indicated airspeed segments. Energy change segments include constant airspeed (indicated, true or Mach) climb or descent segments and level flight acceleration or deceleration segments.

Some of the vertical profile segment types and the associated non-time based integration parameters are shown in Table 1. During vertical profile segments several aircraft configuration quantities are held constant in the present invention. For example, during a constant indicated airspeed climb segment, bank angle, thrust angle, throttle position, flap setting, spoiler position and landing gear position of the aircraft are assumed to be constant to maintain airspeed and lift. The range of throttle positions available for an aircraft in the present invention includes zero “0” (i.e., idle) to one or “1” (i.e., maximum continuous thrust). Bank angle is calculated using a shape function that is based on the following papers by George Hunter, the entirety of which is incorporated by reference: Aircraft Flight Dynamics in the Memphis TRACON, Seagull TM 92120-01, January 1992 and Aircraft Flight Dynamics in the Dallas-Fort Worth TRACON, Seagull TM 93120-01, February 1993.

TABLE 1
Vertical Profile Segment Types and Associated Integration
Parameter

| Segment Type | Integration Parameter |
|---|---|
| Constant Altitude | V |
| Constant Equivalent Airspeed | h |
| Constant Mach Number | h |
| Energy trade | V |
| Constant True Airspeed | h |
| Cruise | R |
| Constant Climb Rate | h |
| Cruise Climb | R |
| Constant Load Factor | γ |
| Constant Climb Angle | R |

A vertical profile segment consists of a segment type and its end point. There are no further degrees of freedom to satisfy any additional constraints on the altitude-velocity segment. Where FAR flight restrictions are applicable, the altitude-velocity segment type and end point must be specified to satisfy the applicable FAR flight restriction.

A climb in a vertical profile is typically specified by multiple integration steps within a single segment type. For example, for a climb from 11,000 feet to 23,000 at constant calibrated airspeed with a step size of 2,000 feet, then the point mass equations will be solved at 11,000, 12,000, 14,000, 16,000, 18,000, 20,000, 22,000 and 23,000. Note that the first and last steps are only 1,000-foot steps. The vertical profile does not specify when turns will occur or the position of the top of the climb. The turn points and the position of the top of the climb are determined as part of the integration of the point mass equations.

The location of the top of descent, on the other hand, is usually specified as part of the vertical profile. One method used in the present invention is to specify the top of descent as a range or an altitude and range from the final point or destination. Another method used by the present invention bases the position of the top of descent on the lift-over-drag characteristics of the aircraft (e.g., gliding capability of aircraft). Alternatively, another method for determining the position of the top of descent uses the pilot's descent angle rule of thumb. The pilot's descent angle rule-of-thumb can be summarized as, airspeed multiplied by 5 equals the rate of descent required (in feet per minute) to maintain a 3-degree approach. For example, an aircraft approaching at a runway at 100 knots airspeed in no-wind conditions must descend at 500 feet per minute to maintain a 3-degree approach path.

### Point Mass Trajectory Function

After the non-time based integration parameter is chosen, the point mass trajectory function uses point mass equations (1)-(5), which are discussed later in this application, and the definition of the path segments to compute the simulated flight path in terms of altitude and velocity. The purpose of this step is to convert the node or specified integration step point, which is typically specified based on a non-time based integration parameter, to energy coordinates. Once the path shape has been determined, a virtual point, which precedes the actual starting point of the segment, is determined (see lines preceding turns in FIG. 1). The virtual point is used to commence aircraft maneuvers to maintain the specified horizontal and vertical flight profiles, as shown in FIG. 1, and/or to change the integration step size used during an aircraft maneuver.

The ability of the present invention to integrate using a non-time based natural variable for a vertical segment reduces the computational requirements and reduces variations in accuracy when compared to time-based integrations for these segments. For example, consider a climbing segment in a vertical profile that specifies a climb at a constant indicated airspeed to 10,000 feet with a step size of 500 feet. If a fighter aircraft and a general aviation airplane are compared flying the same vertical profile, the time to climb to 10,000 feet will be different by an order of magnitude, based on differences in performance characteristics (e.g., engine thrust controls the linearity of the flight path trajectory and engine thrust varies primarily with altitude). In a simulation integrating using time as the integration variable, the time step size would also have to vary by an order of magnitude to achieve the same integration accuracy for each aircraft. The system and method of the present invention overcomes these shortcomings of existing simulations and achieves about the same trajectory accuracy for the two disparate aircraft types with the same step size, by integrating using non-time based integration variables, such as altitude.

The vertical profile and horizontal profile are reconciled during integration by performing an iteration to determine the vertical profile step size that will result in the range that defines either the starting point or ending point of a turn, as shown in FIG. 5. The method of the present invention typically reduces the integration step size approaching the starting point of a turn so that the flight path trajectory can be integrated accurately in the presence of wind. As discussed below, the integration step size can be adjusted to trade off accuracy versus performance. Also, the bank angle is set for the turn so that the point mass equations are solved correctly during the turn. The bank angle for a turn is determined by the present invention based upon the number of degrees of the course change and historical data concerning the angle of bank used for similar aircraft for the required number of degrees of turn. The angle of bank is typically limited to less than 30 degrees for turns of 180 degrees or less. In one embodiment of the present invention, the bank angle is calculated based on the actual integrated true airspeed.

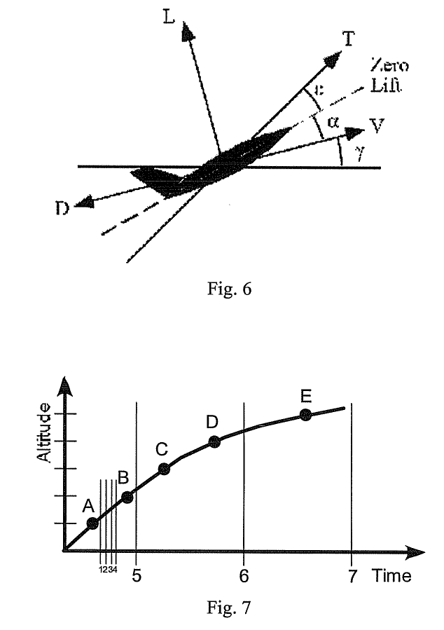

The point mass equations are solved at least at each node in the simulated flight path trajectory, as shown in FIG. 6. The point mass trajectory function adjusts the aircraft's angle of attack so that the forces balance (i.e., equilibrium point) along the flight path and normal to the flight path. The system and method of the present invention solves the point mass equations iteratively and in the same way for each type of segment without making any small angle assumptions. This makes the method more robust than other methods of simulation and simplifies the development of new segment types. Also, the method of the present invention calculates a new weight and specific excess power in closed form, assuming only that the specific excess power and fuel flow vary linearly during the step.

The system and method of the present invention does not approximate aircraft performance characteristics under the following conditions:
Flight conditions where the specific excess thrust is greater than 1.0. (i.e., for flight conditions where an aircraft can climb straight up, such as fighter aircraft with afterburners on or helicopters flying a vertical trajectory (e.g., straight up). These flight conditions are rarely encountered when simulating flight path trajectories;
Aircraft roll-into-turn time (e.g., the time in seconds for an aircraft to transition from wings level to the turn bank angle), which is measured in seconds, is currently ignored. The slight delay error associated with ignoring aircraft roll time has a negligible effect on the simulated aircraft flight path trajectories. However, if necessary, the slight delay error associated with ignoring aircraft roll time can be minimized by modeling the aircraft roll-into-turn time using a slightly different bank angle;
The exact bank angle required for turning in a wind is not modeled. The point mass equations of the present invention are solved for a planned zero wind bank angle. Not modeling the bank angle to account for the effect of winds aloft present introduces a small error in aircraft performance during turns;
The aircraft bank angle is not corrected for the actual speed of the aircraft during the turn. This introduces an error in aircraft performance during turns. This error can be reduced by either improving the true airspeed shape function or by updating the bank angle during integration;
Flight path angle changes are assumed instantaneous. These maneuvers are measured in seconds, or fractions thereof. This introduces a small error in aircraft performance during aircraft pitch-up and push-over maneuvers. However, these maneuvers can be modeled using a special constant load factor segment, which was previously developed by the inventor while at NASA. The usual quasi-steady approximation of equation (3) is replaced with an assumed constant load factor;
   Some of the advantages of the system and method of the present invention are discussed in the following sections and in the solution of the point mass equations section.

### Accuracy of Simulated Flight Path Trajectory

Since the radius of a turn is a simple function of the bank angle and true airspeed, an estimate of true airspeed is needed to plan the turns in the horizontal profile. Some of the existing simulation models integrate the vertical profile without turns in order to estimate the true airspeed in order to determine the turn radius and then recalculate the simulated flight path trajectory using the estimated aircraft airspeed for each turn. However, this approach not only results in higher computational loading and slower response speed but couples the vertical profile in the specification of the horizontal profile. This coupling of the vertical profile in the specification of the horizontal profile is avoided by the present invention. Instead, point mass trajectory uses a true airspeed shape function that is normally a function of aircraft type and independent of the specified vertical profile or horizontal profile.

The true airspeed shape function provides an estimate of true airspeed strictly as a function of range, independent of where or how many turns occur in the flight path trajectory. In general, the advantage of using a shape function is that it is smooth and can be computed very quickly. One specific advantage of using the true airspeed shape function in the point mass equation solution is that small changes in the horizontal profile will result in small changes in the simulated flight path trajectory. Thus, using true airspeed shape functions provides a reasonable specification for the turn radius without having to integrate the vertical profile with the horizontal profile during the specification of the horizontal profile.

Using a true airspeed shape function does not improve the accuracy of the simulated flight path trajectory; in fact, it introduces a source of error into the simulated flight path trajectory of the present invention. However, by providing a reasonable estimation of the true airspeed of the aircraft during turns, the estimated bank angle for the turn will also be reasonable. Since there are a potentially infinite number of bank angle and true airspeed combinations for a specified turn radius, and the affect of the winds aloft present on the bank angle are ignored, there is no “light” answer for the turn radius. As long as the estimated bank angle is reasonable, the simulated flight path trajectory will be reasonable.

As previously noted, the point mass equation solution of the present invention does not correct the estimated “reasonable” bank angle for a turn for the wind conditions aloft present during the turn. While correcting for bank angle would improve the accuracy of the point mass equation solution in turns, this bank angle correction would potentially limit the bank angles available during turns, thereby creating an error condition where very high bank angles are necessary because the actual true airspeed is much higher than the reference airspeed. Any limiting of the bank angles available during turns could result in a serious non-linearity in the solution of the point mass equations, which the present invention avoids.

The use of true airspeed shape functions to provide reasonable bank angles for turns also avoids any discontinuities in the simulated flight path trajectory and enables the point mass trajectory function to keep the simulated flight path trajectory integration function smooth with respect to changes in the trajectory specification and very fast. The use of true airspeed shape functions basically trades a little accuracy for integration function smoothness and speed.

This use of true airspeed shape functions enables the simulated flight path trajectory to be robust, smooth and fast, which is important especially when the point mass trajectory function is embedded in other numerical methods, such as a numerical optimization of the flight path trajectory. An example of this would be determining the flight path trajectory that minimizes fuel burn in a wind field with the vertical profile fixed.

Decoupling Accuracy from Time Step

The integration step size can be adjusted to trade off accuracy versus performance. The method of integration approximates the specific excess energy and the fuel flow as a linear function between integration nodes. If the step size is small, there will be lots of nodes and the trajectory will be very accurate at the expense of more computation.

For purposes of simulation the aircraft state needs to be sampled at some fixed frequency. The sample period is usually called the simulation time step because conventional simulations take steps in time (i.e., Δt). The point mass trajectory function interpolates between integration nodes based on changes in altitude or velocity, for example, which decouples the integration accuracy (which is determined by the integration step size) from the simulation time step.

FIG. 7 illustrates how the interpolation works at two vastly different time steps. Assume that FIG. 7 represents the altitude time history of a climbing aircraft and that the integration step size has been adjusted for the desired level of accuracy. The climb profile is mildly nonlinear so relatively large steps can be used resulting in integration nodes at A, B, C, D, and E. The first sample rate is labeled by times 1, 2, 3, and 4 and is at a high sampling frequency. The aircraft state at points 1-4 are calculated by interpolating between points A and B. The second sample rate, which is at a lower frequency, is labeled by times 5, 6, and 7. In this case, point 5 is calculated by interpolating between points B and C and point 6 is calculated by interpolating between points D and E.

When the simulation frequency is high (e.g., points 1-4), the aircraft simulation of the present invention requires a considerable amount of computations for interpolating between the nodes of the simulated flight path in addition to solving the point mass equations. Where the simulation frequency is lower (e.g., points 5-7), the amount of computations for interpolating is much less. In both cases, the accuracy is controlled by the selected integration step size, not the simulation time step. This results in significantly lower computational requirements than required by existing simulation programs.

In the present invention, the end point for most altitude-velocity segments is specified in terms of the integration variable, so no iteration is required and discrete changes in the vertical profile occur exactly when they should, thereby simulating the flight path trajectory more accurately than existing flight path trajectory simulations. For example, if the integration variable is altitude and the end point of the segment is specified as “climb to 23,000 feet”, then no iteration is required to map to the specified energy coordinates (i.e., altitude). However, if the segment is specified as, “climb to transition altitude”, then an iteration is required to determine that transition altitude.

### Iterative Determination of Change Initiation Points

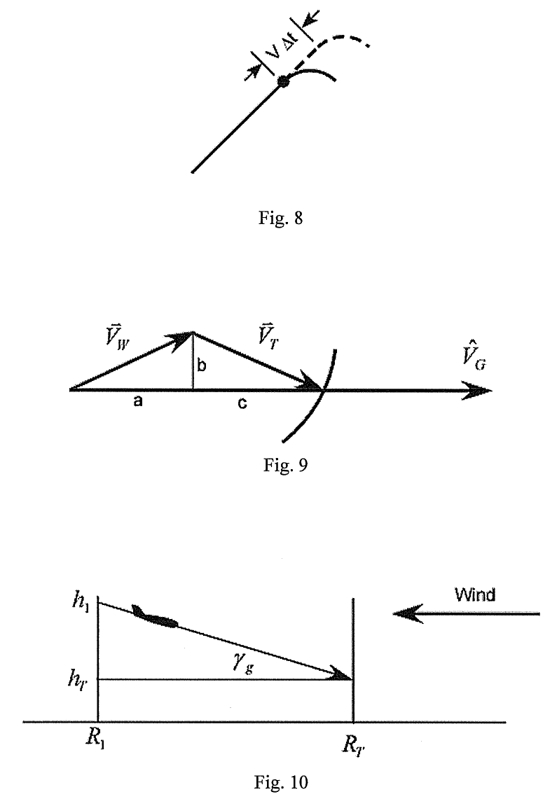

In conventional trajectory integration methods, the initiation of a change in aircraft state (e.g. a turn) is based on the aircraft satisfying one or more discrete events that are determined iteratively using a selected time step (Δt). For example, if a turn is to be started after crossing a waypoint (see FIG. 8), a conventional trajectory method takes a time step, determines whether the waypoint has been crossed, and then starts the turn when the crossing of the waypoint is determined to have occurred. The iterative determination of the initiation point for the change in aircraft state potentially introduces a maximum error that is proportional to the time step (Δt). As shown in FIG. 8, if one time step occurs just before the waypoint is reached, the need to start the turn will not be determined until the aircraft has traveled a distance equal to the ground speed times the time step past the waypoint. The larger the selected time step (Δt) of the trajectory integration method using this technique, the larger the error for the discrete changes. The resulting error can be in either the horizontal or vertical profiles for the aircraft, or both.

The point mass trajectory function avoids this error by using iteration, when necessary, to solve for all discrete changes in the vertical and horizontal profile. For example, if altitude is the integration variable and the desired end state is the transition altitude, the present invention performs an iteration to find the transition altitude to any desired accuracy. The iteration starts with an estimate of the transition altitude and calculates the Mach number for the aircraft climb CAS at the estimated altitude. This calculated Mach number is compared to the aircraft type climb Mach number. The difference between these two Mach numbers is a Mach error that needs to be driven to zero. Using a zero finding technique, the point mass trajectory estimates a new transition altitude from the above determined Mach error. The above calculation may be repeated a fixed number of times to determine the above transition altitude.

### Solution of Point Mass Equations

The point mass equations and the iterative computation of aircraft state are discussed in greater detail in An Accurate And Flexible Trajectory Analysis, the entirety of which is incorporated herein by reference.

The point mass equations apply Newton's Second Law of Motion to a vertical plane containing the center of gravity of the aircraft. The first equation is the force balance, or equilibrium, equation for forces along the flight path.

$$\frac{W}{g} \dot{V} = T cos ( α + ɛ ) - D - W sin γ \qquad ( 1 )$$

where:
W is the aircraft weight in pounds (lbs.);
g is the acceleration due to gravity constant of 32.174 ft/sec²;
\dot{V} is the time derivative of velocity i.e., acceleration) of the aircraft (ft/sec.);
T is the aircraft thrust in pounds (lbs.);
α is the angle of attack relative to aircraft zero lift axis of the aircraft (degrees);
ε is the thrust angle relative to aircraft zero lift (degrees);
D is a aircraft drag (lbs.), and
γ is the flight path angle (degrees).

The angle of attack, which is defined relative to the zero lift axis of the aircraft, is also referred to as the absolute angle of attack. The absolute angle of attack will vary as the required lift coefficient varies. The direction of the relative wind is therefore a degrees nose down from the zero lift axis. The thrust angle, ε, is the angle between the thrust vector and the zero lift axis. The thrust angle is usually small, negative and fixed; although for some aircraft this angle can vary over 90° (e.g., tilt rotor aircraft).

The second equation defines the rate of climb of the aircraft.

\dot{h}=V sin γ (2)

### Where:

\dot{h} is the time derivative of altitude (i.e., rate of climb);
V is the aircraft velocity (ft/sec.), and
γ is the flight path angle (degrees).
   Note that this equation is valid even when the aircraft is in a turn (i.e., at an angle of bank greater than 0).

The third equation is the force balance, or equilibrium, equation for forces normal to the flight path.

$$\frac{W}{g} V \dot{γ} = [ L + T sin ( α + ɛ ) ] cos φ - W cos γ \qquad ( 3 )$$

### Where:

W is the aircraft weight in pounds (lbs.);
g is the acceleration due to gravity constant of 32.174 ft/sec²;
V is the aircraft velocity (ft/sec.);
\dot{γ} is the time derivative of the flight path angle (degrees);
L is aircraft generated lift (lbs-force);
T is the aircraft thrust in pounds (lbs.);
α is the angle of attack relative to aircraft zero lift axis of the aircraft (degrees);
ε is the thrust angle relative to aircraft zero lift (degrees);
φ is the bank angle (degrees), and
γ is the flight path angle (degrees).

Note that this equation does not use small angle approximations, which are a source of error. The inclusion of bank angle φ in the third equation makes this equation exact for turning flight.

The change in weight due to fuel consumption is defined by the fourth equation.

\dot{W}=−f (4)

### Where:

\dot{W} is the change (time derivative) of the aircraft weight due to fuel consumption, and
f is the fuel flow rate (lbs/sec).

The fourth equation defines the weight that couples the first, third and fifth equations. The system and method of the present invention assumes that equation (3) equals zero. This enables equations (1)-(4) to be solved with high accuracy at each node.

The fifth equation relates the turn rate to the bank angle and forces in the horizontal plane normal to current heading.

$$\frac{W}{g} V \dot{Ψ} = [ L + T sin ( α + ɛ ) ] sin φ \qquad ( 5 )$$

### Where:

W is the aircraft weight in pounds (lbs.);
g is the acceleration due to gravity constant of 32.174 ft/sec²;
V is the aircraft velocity (ft/sec.);
Ψ is the heading angle (degrees) (where north=0°)
L is aircraft generated lift (lbs-force);
T is the aircraft thrust in pounds (lbs.);
α is the angle of attack relative to aircraft zero lift axis of the aircraft (degrees);
ε is the thrust angle relative to aircraft zero lift (degrees), and
φ is the bank angle (degrees).

Again, this equation does not use small angle approximations, which are a source of error. The inclusion of bank angle φ in the fifth equation makes this equation exact for turning flight.

The sixth equation introduces the specific energy of the aircraft. The specific energy follows directly from the physics definition of energy (potential energy plus kinetic energy):

$$E = mgh + \frac{1}{2} {mV}^{2} = Wh + \frac{1}{2} \frac{W}{g} {V}^{2}$$

Dividing by weight gives the specific energy of the aircraft as,

$$e = h + \frac{{V}^{2}}{2 g} \qquad ( 6 )$$

### Where:

e is the specific energy of the aircraft;
h is the altitude (feet);
V is the aircraft velocity (ft/sec.), and
g is the acceleration due to gravity constant of 32.174 ft/sec².

The specific energy of the aircraft is the total energy (i.e., kinetic energy+potential energy) normalized by the aircraft weight.

Taking the derivative of equation (6) and substituting from equations (1) and (2), results in the following:

$$\dot{e} = V \frac{T cos ( α + ɛ ) - D}{W} ≡ {P}_{s} = V \cdot {n}_{x} \qquad ( 7 )$$

where:
Pₛ is the specific excess power (ft/sec);
V is the aircraft velocity (ft/sec.), and
nₓ is the available horizontal acceleration in g's.

Equation (6) eliminates the flight path angle, γ, from the first and second equations, resulting in the seventh equation, which states that the change in the specific energy of the aircraft equals the specific excess power. The nₓ multiplying velocity represents the available horizontal acceleration in g's for the current flight conditions. The nₓ value is also known as specific excess thrust.

Based on the analysis above, the aircraft's flight path trajectory is controlled by two variables: Pₛ and γ. Pₛ controls the total net power added to the aircraft, and γ controls the way the available power is divided between potential energy, represented by h, and kinetic energy, represented by V. A pilot controls Pₛ and h variables by using the throttle and elevator controls to control the airframe dynamics.

Equations (2) and (7) can be combined to obtain equation (8).

Sin γ=nₓ\dot{h}/ė=nₓ(Δh/Δe) (8)

Equation (8) can be used to approximate γ at the flight path nodes.

The method of the present invention assumes that the integrated average value of the specific power and the fuel flow is the simple average of their respective values at adjacent nodes. No small angle assumptions are made in this method. The calculated thrust, lift and drag values can be functions of the angle of attack, Mach number and altitude.

Further the system and method of the present invention can be used in situations where both the angle of attack and the thrust angle are large.

The equilibrium equations (i.e., equations (1)-(4)) will typically require an iteration to solve in practice because both the aerodynamic and propulsion models may be non-analytic and can have discontinuities relative to particular flight conditions. For example, many propulsion (engine) models use table interpolations, which results in non-smooth behavior.

### Iterative Computation of Aircraft State

Assuming that the state of the aircraft is known at a first point, this section describes the method of the present invention for computing the state of the aircraft at subsequent points on the simulated flight path. The described method is responsible for the high accuracy of the integration of the vertical profile. The state variables to permit the integration are altitude, velocity, weight, time, range and flight path angle. Solving the equilibrium equations iteratively is basically a one-dimension search for a fixed point for a function defined by equations (3), (7) and (8), with equation (3) set to equal zero or specified and the independent variable is the lift coefficient.

The first step is to get the next node, which is defined by an altitude and a velocity. Next, the new lift coefficient is estimated from the weight coefficient using the following equation:

C_{W}=W/qS (9)

### Where:

C_{W} is the weight coefficient;
W is the aircraft weight (lbs);
q is the dynamic pressure (lbs per square foot), and
S is the aircraft's plan form area (sq. ft.).

The weight coefficient is a good starting point even for steep climbs where the final lift coefficient is considerably less. The angle of attack is computed from the lift coefficient, either directly or by iteration. In a more coupled vehicle, such as a hypersonic aircraft, the angle of attack can be used as the independent variable and the lift coefficient is calculated from the angle of attack.

The next step is to calculate the drag, thrust and fuel flow for the aircraft. The aerodynamics and propulsion models can calculate the exact drag, thrust and fuel flow of an aircraft for a given lift coefficient. In the most general case, each of these variables can be determined as a function of the angle of attack. At this point, the specific energy and fuel flow at the new point can be calculated exactly using the aerodynamics and propulsion models.

The next step is to compute a new weight for the aircraft. To calculate the new weight, the values for the average specific power and the average fuel flow rate are required. This method assumes that the integrated average value of the specific power and fuel flow rate is the simple average of their values at adjacent nodes. Therefore, the excess power available for horizontal acceleration is defined as:

Pₓ=WPₛ=V(T cos(α+ε)−D) (10)

### Where:

Pₓ is the excess power (ft-lbs/sec);
W is the aircraft weight (lbs);
Pₛ is the specific excess power (ft/sec);
V is the aircraft velocity (ft/sec.);
T is the aircraft thrust in pounds (lbs.);
α is the angle of attack relative to aircraft zero lift axis of the aircraft (degrees);
ε is the thrust angle relative to aircraft zero lift (degrees), and
D is the aircraft drag (lbs.).

According to the system and method of the present invention, the following equations can be solved analytically for the new excess power and weight.

f̅≈½(f₁+f₂) (11)

Where:
f̅ is the integrated average fuel flow rate (lbs/sec);
f₁ is the fuel flow rate at point 1 (lbs/sec), and
f₂ is the fuel flow rate at point 2 (lbs/sec).

[symbol]

≅ P̅ₛ=½(Pₛ₁+Pₛ₂) (12)

### Where:

[symbol] is time derivative of the integrated average of specific energy;
P̅ₛ is the integrated average of the specific excess power (fps);
Pₛ₁ is the specific excess energy at point 1, and
Pₛ₂ is the specific excess energy at point 2.

Δt≅Δe/ P̅ₛ (13)

### Where:

Δt is the change in time (sec);
Δe is the change in specific energy (ft), and
P̅ₛ is the integrated average of the specific excess power (fps).

W₂=W₁−_{f}Δt (14)

### Where:

W₂ is the aircraft weight at point 2;
W₁ is the aircraft weight at point 1;
f is the integrated average fuel flow rate (lbs/sec), and
Δt is the change in time (sec).

nₓ₂=(T₂ cos(α₂+ε₂)−D₂)/W₂ (15)

### Where:

nₓ₂ is the available horizontal acceleration at point 2 (in g's);
T₂ is aircraft thrust at point 2;
α₂ is the angle of attack relative to aircraft zero lift axis of the aircraft (degrees) at point 2;
ε₂ is the thrust angle relative to aircraft zero lift (degrees) at point 2,
D₂ is the aircraft drag at point 2 (lbs.), and
W₂ is the aircraft weight at point 2.

Pₛ₂=nₓ₂V₂ (16)

### Where:

Pₛ₂ is the specific excess energy at point 2;
nₓ₂ is the available horizontal acceleration at point 2 (in g's), and
V₂ is the aircraft velocity at point 2 (ft/sec.).

### Derivation of Weight

The new specific excess power, Pₛ, depends on the average fuel flow rate through changes in the gross weight of the aircraft. More specifically, specific excess power at point 2, Pₛ₂, is dependent on the final weight, W₂, of the aircraft, which is not known. Existing flight path trajectory models require one or more iterations to determine a final weight for the aircraft. In contrast, the point mass trajectory methodology of the present invention analytically solves equations (12) through (16) to determine the new specific excess power, Pₛ₂, and weight, W₂, without iterating the trajectory, which speeds up these calculations, making the present invention more efficient than trajectory models that iterate.

By starting with equation (16), and backsolving using equations (12) through (15) as described below, an explicit quadratic equation is determined for Pₛ₂ that can be solved without iteration. First, the excess power (available for horizontal acceleration) is defined as:

Pₓ=WPₛ=V·(T cos(α+ε)−D) (17)

### Where:

Pₓ is the excess power available for horizontal acceleration (ft-lbs/sec);
W is the aircraft weight (lbs);
Pₛ is the specific excess power (ft/sec);
V is the aircraft velocity (ft/sec.);
T is the aircraft thrust in pounds (lbs.);
α is the angle of attack relative to aircraft zero lift axis of the aircraft (degrees);
ε is the thrust angle relative to aircraft zero lift (degrees), and
D is the aircraft drag (lbs.).

The values for the variables shown on the right hand side of equation (17) are known for both the initial point and the new point. Next, combining equations (14) through (17) provides the following equation for excess power:

$${P}_{S 2} = \frac{{P}_{X 2}}{{W}_{1} - \overline{f} Δ t} \qquad ( 18 )$$

### Where:

Pₛ₂ is the specific excess energy at point 2;
Pₓ₂ is the excess power for horizontal acceleration at point 2 (ft-lbs/sec);
W₁ is the aircraft weight at point 1;
f̅ is the integrated average fuel flow rate (lbs/sec), and
Δt is the change in time (sec).

Then, combining equation (18), equation (12), and equation (13) provides the following equation for excess power:

$${P}_{S 2} = \frac{\frac{{P}_{X 2}}{2 \overline{f} Δ e}}{{P}_{S 1 +} {P}_{X 2}} \qquad ( 19 )$$

### Where:

Pₛ₂ is the specific excess energy at point 2;
Pₓ₂ is the excess power available for horizontal acceleration at point 2 (ft-lbs/sec);
W₁ is the aircraft weight at point 1;
f̅ is the integrated average fuel flow rate (lbs/sec);
Δe is the change in specific energy (ft);
Pₛ₁ is the specific excess energy at point 1, and
Pₛ₂ is the specific excess energy at point 2.

Next, equation (19) is expanded to provide the following quadratic in Pₛ₂:

W₁P_{S2}²+(W₁P_{S1}−2 f̅Δe−P_{X2})P_{S2}−P_{X2}P_{S1}=0 (20)

### Where:

W₁ is the aircraft weight at point 1;
Pₛ₂ is the specific excess energy at point 2;
Pₛ₁ is the specific excess energy at point 1;
f̅ is the integrated average fuel flow rate (lbs/sec);
Δe is the change in specific energy (ft), and
Pₓ₂ is the excess power for horizontal acceleration at point 2 (ft-lbs/sec);

For convenience, the middle coefficient is defined as:

P*=P_{X2}−P_{X1}+2 f̅Δe (21)

### Where:

Pₓ₂ is the excess power for horizontal acceleration at point 2 (ft-lbs/sec);
Pₓ₁ is the excess power for horizontal acceleration at point 1 (ft-lbs/sec);
f̅ is the integrated average fuel flow rate (lbs/sec), and
Δe is the change in specific energy (ft).

Substituting equation (21) into equation (20) and applying the quadratic formula yields the following solution for the excess power, Pₛ₂:

$${P}_{S 2} = \frac{{P}^{*} + \sqrt{{( {P}^{*} )}^{2} + 4 {P}_{X 1} {P}_{X 2}}}{2 {W}_{1}} \qquad ( 22 )$$

### Where:

Pₓ₂ is the excess power for horizontal acceleration at point 2 (ft-lbs/sec);
Pₓ₁ is the excess power for horizontal acceleration at point 1 (ft-lbs/sec):
P* is defined by equation (21), and
W₁ is the aircraft weight at point 1.

Equation (22) is the basic analytic solution for excess power, however, getting the signs correct for the equation variables is subtle. In the present invention, the following solution has been found to work for all possible signs of Pₓ₁, Pₓ₂, and Δe:

P*=|P_{X2}|−|P_{X1}|+sign(Pₓ₁)sign(P_{X2})2 f̅|Δe|

This results in the following analytic solution for excess power:

$${P}_{S 2} = sign ( {P}_{X 1} ) \cdot \frac{[ {P}^{*} \sqrt{{( {P}^{*} )}^{2} \cdot 4 \vert {P}_{X 1} \vert \vert {P}_{X 2} \vert} ]}{2 {W}_{1}} \qquad ( 23 )$$

### Where:

Pₛ₂ is the specific excess energy at point 2;
Pₓ₁ is the excess power for horizontal acceleration at point 1 (ft-lbs/sec);
   |Pₓ₂| is the absolute value of the excess power for horizontal acceleration at point 2 (ft-lbs/sec);
   |Pₓ₁| is the absolute value of the excess power for horizontal acceleration at point 1 (ft-lbs/sec), and
W₁ is the aircraft weight at point 1.

In the present invention, the computations for the analytic solution described above are done in double precision due to the possibility of roundoff error in the bracketed expression in the numerator of equation (23). The following assumptions are included as part of the methodology of the present invention: the linear assumption for the average specific power of equation (12) provides the basis for the quadratic of equation (20). In another embodiment of the present invention, a weighted average is used for the average specific power of equation (12), which also results in a quadratic equation solution. However, other assumed functions for the average specific power result in other solution forms that are not explicitly solvable.

The methodology of the present invention improves the accuracy of the simulated flight path trajectory in the following ways. First, the methodology of the present invention accurately solves the point mass equilibrium equations, equations (1) through (5), at each node. This is true even where large angles of attack (AOA), thrust angles or flight path angles are present. In contrast, existing trajectory models either restrict the range for AOA, thrust angles or flight path angles available or the existing models are unable to compute solutions where large AOA, thrust angles or flight path angles are present. Second, the methodology of the present invention integrates the aircraft weight more accurately using the explicit solution of equation (23) in combination with equations (12) through (14). When the simulated trajectories of the present invention were compared to the results from the ACSYNT, the NASA Ames Research Center Aircraft Synthesis Program, the fuel weight error of the present invention for a flight path trajectory of 10 or more nodes was 0.2% while the ACSYNT fuel weight error was 2.6%. Thus, the fuel weight error of present invention was more than an order of magnitude more accurate for the simulated flight path trajectory.

### Aircraft True Course not Affected by Wind

In a conventional simulation, the true course of the aircraft is determined using a multi-step process. First, the true airspeed is calculated by taking a time step in the vertical profile. Then, the true heading is determined by integrating the lateral equations. Using the calculated true heading of the aircraft, the true velocity vector is then determined. Finally, the true velocity vector is added to the wind vector to s produce the calculated true course and ground speed of the aircraft. In this conventional simulation, the true course is computed rather than specified. The problem with this is that the aircraft can wander off the specified horizontal profile.

In the point mass trajectory function, the true airspeed is also calculated by taking a step (e.g., altitude or velocity or range) in the vertical profile. In the system and method of the present invention the prescribed true course, calculated true airspeed, and the wind vector at the current position are used to calculate the true heading and groundspeed. Note that the true heading is calculated, not the true course. The method of the present invention is in effect calculating the heading that would be required to implement the prescribed true course in the current wind field.

For example, FIG. 9 shows a situation in which an aircraft has a tail wind. The wind vector, true airspeed vector magnitude and ground vector direction are specified. Conceptually, the problem is to rotate the true airspeed vector about the tail of the wind vector until it intersects the ground speed direction. Then the magnitude of the ground speed and the direction of the true airspeed vector can be calculated. The magnitude, a, is the wind component in the ground vector direction and is given by the dot product of the wind with the ground direction:

a=V_{W}_{_{G}}−\hat{V}_{G}·\vec{V}_{W} (24)

where:
\hat{V}_{G} is the unit vector in the true course direction.
   The magnitude, b, is then calculated using the Pythagoras theorem:

b=\sqrt{V_{W}²−a²}={square root over (V_{W}²−V_{W}_{_{G}}²)} (25)

Similarly, c can be calculated as:

c=\sqrt{V_{T}²−b²}=\sqrt{V_{T}²−(V_{W}²−V_{W}_{_{G}}²)}={square root over (V_{T}²+V_{W}_{_{G}}²−V_{W}²)} (26)

The magnitude of the ground vector is then given by:

V_{G}=a+c=V_{W}_{_{G}}+{square root over (V_{T}²+V_{W}_{_{G}}²−V_{W}²)} (27)

The heading angle can now be calculated from the magnitudes of b and c from equations (23) and (24):

$$ψ = {tan}^{- 1} [ \frac{c}{b} ] \qquad ( 28 )$$

Note that there are situation in which the quantity under the radical in equation (27) can be negative. For example, in situations where there is a high wind and the aircraft has a low true airspeed. In this situation, the true airspeed vector, shown in FIG. 9, is not long enough to reach the ground speed direction and the quantity calculated by equation (26) is assumed to be zero. It is also possible for the ground speed magnitude calculated by equation (27) to be zero or negative. This situation occurs, again, when there is a very large head wind.

### Accurately Achieving Descent to Destination

The climb phase of a flight is normally conducted at a fixed throttle setting, namely maximum continuous power or thrust. The point at which the aircraft finishes the climb is not particularly important as the aircraft typically transitions to an en route phase of flight. During the en route phase of flight, the airspeed and altitude typically are constant with minimal throttle changes by the pilot.

In contrast, the descent phase of flight, specifically the final portions of the descent phase of flight, are normally not flown at fixed throttle and are very important for arriving at the destination, a target altitude and distance from the end of the runway. During the descent phase, the throttle is adjusted to fly a descent path that will intersect the desired end point.

FIG. 10 shows a situation where an aircraft starts from an initial altitude and range, h₁ and R₁, and the descent is controlled such that the aircraft hits a target altitude, hₜ, at a specified target range, R_{T}, in the presence of wind. Assuming a constant angle of descent with respect to the ground, the geometry of the descent shown in FIG. 10, can be written as the flowing equation:

$$tan {γ}_{g} = \frac{{h}_{T} - {h}_{1}}{{R}_{T} - {R}_{1}} = \frac{Δ h}{Δ x} \qquad ( 29 )$$

In equation (29), the delta quantities refer to an integration step, the numerator quantities are changes in altitude (h), and the denominator quantities are changes in distance along the ground. Assuming a constant ground speed during an integration step, the distance traveled along the ground (including the effect of the wind) is the ground speed times the time change during the integration step:

$$Δ x = \frac{Δ h}{tan {γ}_{g}} {V}_{G} Δ t \qquad ( 30 )$$

Now assuming that the true airspeed and available level flight acceleration in g's, are constant over the integration step, then using equation (8) the time change during the step can be calculated as follows:

$$Δ t = \frac{Δ e}{\dot{e}} = \frac{Δ e}{{V}_{T} {n}_{x}} \qquad ( 31 )$$

Substituting for time change Δt into equation (30) results as follows:

$$\frac{Δ h}{tan {γ}_{g}} = {V}_{G} \frac{Δ e}{{V}_{T} {n}_{x}} \qquad ( 32 )$$

Solving equation (32) for nₓ and substituting from equation (29) calculates the required specific excess thrust for the specified integration step as:

$${n}_{xreg} = \frac{{V}_{G}}{{V}_{T}} \frac{Δ e}{Δ h} tan {γ}_{g} = \frac{{V}_{G}}{{V}_{T}} \frac{Δ e}{Δ h} \frac{{h}_{T} - {h}_{1}}{{R}_{T} - {R}_{1}} \qquad ( 33 )$$

nₓ is also the specific excess thrust of equation (7), which is defined as:

$${n}_{xreq} = \frac{{T}_{req} cos ( α + ɛ ) - D}{W} \qquad ( 34 )$$

Solving for the required thrust gives:

$${T}_{req} = \frac{{Wn}_{xreq} + D}{cos ( α + ɛ )} \qquad ( 35 )$$

Equations (33) and (35) are used by the point mass trajectory function to accurately hit target altitudes even where strong head winds and tail winds are present. However, if the wind vector changes rapidly enough, the feedback loop of the present invention may not react quickly enough to descend to intersect the target altitude, hₜ, at a specified target range, R_{T}. More specifically, where a strong tail wind is present, the thrust required by equation (35) to intersect the target altitude, hₜ, at a specified target range, R_{T}, may be a negative value, indicating that the aircraft does not have sufficient drag to descend at the necessary rate of descent at idle thrust. In this case, the aircraft will arrive at the desired target range at an altitude higher than desired and will achieve the target altitude further downstream.

### Point Mass Equation Calculation Example

### Overview

The following sections present point mass trajectory calculations for a Boeing 767-300ER with PW 4060 engines modeled using BADA 3.6 aircraft type B763 as an example of the present invention. The route goes from KSFO to KDFW to KBOS. Waypoints are inserted to cause turns during the climb and cruise. The cruise condition is 37,000 feet at Mach 0.80. A steady 50 knot wind blows from the north.

### Results and Analysis

The sample flight plan is analyzed using an implementation of the point mass trajectory where the aerodynamic and propulsion models are BADA 3.6. The standard jet profile uses the aircraft type characteristic speeds to build a vertical profile from taxi out to taxi in.

The present invention outputs two files. The first presents the state at each point mass node. The point mass equations are solved at each such node. The second file presents the state at a fixed sample period. Only the first of these files is described in detail in the following sections.

### Trajectory Specification

The first part of the point mass trajectory state file presents the vertical profile specification which is shown below. The specification consists of 19 vertical profile segments. The units of all speeds are knots true airspeed. For each segment, the segment type, step size, and end conditions are listed and additional details that must be specified are discussed below.

### 1. Taxi Segment

Range Step Size: 0.1 nautical miles

End Range: 0.5 nautical miles

Taxi Speed: 3.0

### 2. Ground Roll Segment

Velocity Step Size: 10.0 knots

End Ground Speed: 146.4 knots

### 3. Energy Trade Segment

Velocity Step Size: 10.0 knots

End Velocity: 260.8222681927515 knots

End Altitude: 3000.0 feet

### 4. Constant Indicated Airspeed Climb Segment

Altitude Step Size: 1000.0 feet

End Altitude: 10000.0 feet

### 5. Energy Trade Segment

Velocity Step Size: 10.0 knots

End Velocity: 343.94223063907276 knots

End Altitude: 12000.0 feet

### 6. Constant Indicated Airspeed Climb Segment

Altitude Step Size: 1000.0 feet

End Altitude: 30894.740175336166 feet

### 7. Constant Mach Climb Segment

Altitude Step Size: 1000.0 feet

End Altitude: 37000.0 feet

### 8. Acceleration Segment

Velocity Step Size: 10.0 knots

End Velocity: 459.04312052853226 knots

### 9. Cruise Segment

Range Step Size: 100.0 nautical miles

End Range: 2491.940155226909 nautical miles

### 10. Acceleration Segment

Velocity Step Size: 10.0 knots

End Velocity: 447.56704251531886 knots

### 11. Constant Mach Climb Segment

Altitude Step Size: 1000.0 feet

End Altitude: 30894.740175336166 feet

### 12. Controlled Constant Indicated Airspeed Climb Segment

Altitude Step Size: 1000.0 feet

End Altitude: 12000.0 feet

End Range: 2572.413412589344 nautical miles.

### 13. Energy Trade Segment

Velocity Step Size: 10.0 knots

End Velocity: 288.70261077661644 knots

End Altitude: 10000.0 feet

### 14. Controlled Energy Trade Segment

Velocity Step Size: 10.0 knots

End Velocity: 182.75510615551133 knots

End Altitude: 3000.0 feet

End Range: 2625.072211035244 nautical miles.

### 15. Controlled Energy Trade Segment

Velocity Step Size: 10.0 knots

End Velocity: 150.32708229464885 knots

End Altitude: 1592.1785974909387 feet

End Range: 2635.072211035244 nautical miles.

### 16. Controlled Constant Indicated Airspeed Climb Segment

Altitude Step Size: 200.0 feet

End Altitude: 0.0 feet

End Range: 2640.072211035244 nautical miles.

### 17. Ground Roll Segment

Velocity Step Size: 10.0 knots

End Ground Speed: 30.0 knots

### 18. Taxi Segment

Range Step Size: 0.1 nautical miles

End Range: 2640.89510520311 nautical miles

Taxi Speed: 30.0

### 19. Taxi Segment

Range Step Size: 0.1 nautical miles

End Range: 2641.395105205766 nautical miles

Taxi Speed: 6.0

The bottom of the file reports the worst convergence errors throughout the entire calculation:

Maximum equilibrium convergence error: 1.543126026959385E-8 at range 300.0 nautical miles.

Maximum delta range convergence error: 4.8978741825633776E-5 nautical miles occurred at range 63.87906729339126 nautical miles.

The first line says that the worst error in the point mass equation convergence after four iterations is about one part in 100 billion. More specifically, the difference between the lift coefficient estimate after three iterations and the lift coefficient estimate after four iterations is about 1.5E-8.

The second line says that the worst error for converging on range for the start and end of turns after four iterations is about 0.00005 nautical miles which is about 4 inches.

There are 214 points in the trajectory which means the point mass equations were solved about this many times during the calculation.

The Boeing 767 characteristic speeds from BADA 3.6 are given below for reference:
Clean stall speed—165 knots indicated
Takeoff stall speed—122 knots indicated
Landing stall speed—113 knots indicated
Climb CAS—290 knots indicated
Climb Mach—0.78
Descent CAS—290 knots indicated
Descent Mach—0.78

The route contains five points defined as follows:
KSFO=37:37:00/−122:22:00
ZIG_LEFT=move along a great circle from KSFO heading 45 degrees (northeast) a distance 35 nautical miles
ZIG_RIGHT=move along a great circle from ZIG_LEFT heading 135 degrees (southeast) a distance 35 nautical miles
KDFW=32:54:00/−97:02:00
KBOS=42:22:00/−71:00:00

### Taxi Out and Takeoff

The next three tables show trajectory state data for the taxi and takeoff ground roll to liftoff speed.

| Elapsed Time | Range | Fuel Burn | Altitude | TAS | IAS | | | Climb Rate |
|---|---|---|---|---|---|---|---|---|
| [h:mm:ss.000] | [nmi] | [lbs] | [ft] | [knots] | [knots] | Mach | Nx | [fpm] |
| 0:00:00.000 | 0.000 | 0.0 | 0 | 47.93 | 47.93 | 0.0724 | 0.0000 | 0 |
| 0:02:00.000 | 0.100 | 372.0 | 0 | 47.93 | 47.93 | 0.0724 | 0.0000 | 0 |
| 0:04:00.000 | 0.200 | 743.9 | 0 | 47.93 | 47.93 | 0.0724 | 0.0000 | 0 |
| 0:06:00.000 | 0.300 | 1115.3 | 0 | 47.93 | 47.93 | 0.0724 | 0.0000 | 0 |
| 0:08:00.000 | 0.400 | 1486.4 | 0 | 47.93 | 47.93 | 0.0724 | 0.0000 | 0 |
| 0:10:00.000 | 0.500 | 1857.1 | 0 | 47.93 | 47.93 | 0.0724 | 0.0000 | 0 |
| 0:10:01.267 | 0.502 | 1872.2 | 0 | 57.51 | 57.51 | 0.0869 | 0.2201 | 0 |
| 0:10:03.231 | 0.510 | 1895.5 | 0 | 65.68 | 65.68 | 0.0993 | 0.2169 | 0 |
| 0:10:05.335 | 0.525 | 1920.3 | 0 | 74.31 | 74.31 | 0.1123 | 0.2132 | 0 |
| 0:10:07.554 | 0.547 | 1946.3 | 0 | 83.24 | 83.24 | 0.1258 | 0.2093 | 0 |
| 0:10:09.872 | 0.576 | 1973.3 | 0 | 92.39 | 92.39 | 0.1396 | 0.2051 | 0 |
| 0:10:12.280 | 0.612 | 2001.2 | 0 | 101.70 | 101.70 | 0.1537 | 0.2007 | 0 |
| 0:10:14.776 | 0.657 | 2030.0 | 0 | 111.13 | 111.13 | 0.1679 | 0.1960 | 0 |
| 0:10:17.359 | 0.711 | 2059.6 | 0 | 120.65 | 120.65 | 0.1823 | 0.1910 | 0 |
| 0:10:20.032 | 0.774 | 2089.9 | 0 | 130.25 | 130.25 | 0.1968 | 0.1858 | 0 |
| 0:10:22.798 | 0.847 | 2121.2 | 0 | 139.90 | 139.90 | 0.2114 | 0.1804 | 0 |
| 0:10:24.710 | 0.902 | 2142.7 | 0 | 146.40 | 146.40 | 0.2212 | 0.1766 | 0 |

| Elapsed Time | Weight | Lift | Thrust | Drag | Alpha | Gamma | Latitude | Longitude |
|---|---|---|---|---|---|---|---|---|
| [h:mm:ss.000] | [lbs] | [lbs] | [lbs] | [lbs] | [degrees] | [degrees] | [degrees] | [degrees] |
| 0:00:00.000 | 330,693 | 0 | 18,313 | 1,778 | 0.00 | 0.00 | 37.623 | −122.359 |
| 0:02:00.000 | 330,321 | 0 | 18,313 | 1,778 | 0.00 | 0.00 | 37.621 | −122.361 |
| 0:04:00.000 | 329,950 | 0 | 18,295 | 1,778 | 0.00 | 0.00 | 37.620 | −122.362 |
| 0:06:00.000 | 329,578 | 0 | 18,276 | 1,778 | 0.00 | 0.00 | 37.619 | −122.364 |
| 0:08:00.000 | 329,207 | 0 | 18,257 | 1,778 | 0.00 | 0.00 | 37.618 | −122.365 |
| 0:10:00.000 | 328,836 | 0 | 18,239 | 1,778 | 0.00 | 0.00 | 37.617 | −122.367 |
| 0:10:01.267 | 328,821 | 0 | 90,054 | 1,229 | 0.00 | 0.00 | 37.617 | −122.367 |
| 0:10:03.231 | 328,798 | 0 | 89,347 | 1,603 | 0.00 | 0.00 | 37.617 | −122.367 |
| 0:10:05.335 | 328,773 | 0 | 88,601 | 2,052 | 0.00 | 0.00 | 37.617 | −122.366 |
| 0:10:07.554 | 328,747 | 0 | 87,830 | 2,575 | 0.00 | 0.00 | 37.617 | −122.366 |
| 0:10:09.872 | 328,720 | 0 | 87,042 | 3,172 | 0.00 | 0.00 | 37.618 | −122.366 |
| 0:10:12.280 | 328,692 | 0 | 86,240 | 3,844 | 0.00 | 0.00 | 37.618 | −122.365 |
| 0:10:14.776 | 328,663 | 0 | 85,430 | 4,590 | 0.00 | 0.00 | 37.619 | −122.364 |
| 0:10:17.359 | 328,634 | 0 | 84,614 | 5,410 | 0.00 | 0.00 | 37.619 | −122.364 |
| 0:10:20.032 | 328,603 | 0 | 83,794 | 6,305 | 0.00 | 0.00 | 37.620 | −122.363 |
| 0:10:22.798 | 328,572 | 0 | 82,970 | 7,274 | 0.00 | 0.00 | 37.621 | −122.361 |
| 0:10:24.710 | 328,551 | 0 | 82,417 | 7,966 | 0.00 | 0.00 | 37.621 | −122.361 |

| Elapsed Time | Ground Speed | True Course | Heading | Roll Angle |
|---|---|---|---|---|
| [h:mm:ss.000] | [knots] | [degrees] | [degrees] | [degrees] |
| 0:00:00.000 | 3.00 | 225.00 | 225.00 | 0.00 |
| 0:02:00.000 | 3.00 | 225.00 | 225.00 | 0.00 |
| 0:04:00.000 | 3.00 | 225.00 | 225.00 | 0.00 |
| 0:06:00.000 | 3.00 | 225.00 | 225.00 | 0.00 |
| 0:08:00.000 | 3.00 | 225.00 | 225.00 | 0.00 |
| 0:10:00.000 | 3.00 | 225.00 | 225.00 | 0.00 |
| 0:10:01.267 | 10.00 | 45.00 | 45.00 | 0.00 |
| 0:10:03.231 | 20.00 | 45.00 | 45.00 | 0.00 |
| 0:10:05.335 | 30.00 | 45.00 | 45.00 | 0.00 |
| 0:10:07.554 | 40.00 | 45.00 | 45.00 | 0.00 |
| 0:10:09.872 | 50.00 | 45.00 | 45.00 | 0.00 |
| 0:10:12.280 | 60.00 | 45.00 | 45.00 | 0.00 |
| 0:10:14.776 | 70.00 | 45.00 | 45.00 | 0.00 |
| 0:10:17.359 | 80.00 | 45.00 | 45.00 | 0.00 |
| 0:10:20.032 | 90.00 | 45.00 | 45.00 | 0.00 |
| 0:10:22.798 | 100.00 | 45.00 | 45.00 | 0.00 |
| 0:10:24.710 | 106.71 | 45.00 | 45.00 | 0.00 |

The taxi out is the first six points. The taxi is for 0.5 nautical miles at 3 knots and is simply designed to use up 10 minutes while taxiing.

The indicated airspeed during taxi is about 48 knots which mostly reflects the runway component of the 50 knot wind from the north. The runway true course is 45 degrees so the wind is a quartering headwind from the left. Note that the true course and heading are identical during takeoff. In terms of aerodynamics, the crosswind component is ignored.

The takeoff takes about 25 seconds and starts at a ground speed of 3 knots and concludes at a ground speed of 106.71 knots. With the wind this corresponds to 146.4 knots indicated which is 1.2 times the takeoff stall speed of 122 knots. The takeoff is relatively short because of the head wind. The takeoff time and distance is consistent with the acceleration in g's which varies from 0.22 down to 0.178.

The thrust during taxi is surprisingly high at 18,000 pounds. This is based on the drag and a rolling coefficient of friction of 0.02. This is supported by Balkwill, K. J.: Development of a Comprehensive Method for Modelling Performance of Aircraft Tyres Rolling or Braking on Dry and Precipitation Contaminated Runways. ESDU International report TP 14289E, May 2003.

The thrust varies during takeoff from 90,000 pounds to 82,000 pounds. The BADA propulsion model does not model speeds less than climb speed and is solely a function of altitude. The sea level thrust for the BADA 3.6 B763 is about 70,000 pounds which is quite low compared to the actual sea level static thrust of the Boeing 767-300 ER with the PW 4060 engines of 120,000 pounds. In order to model the takeoff, I model thrust below climb speed by following a fundamental propulsion curve which is given by equation 6.78, page 384, in McCormick, Barnes W., Aerodynamics, Aeronautics, and Flight Mechanics, John Wiley & Sons, 1979. This curve requires two quantities which are not available in the BADA data: engine induced velocity and sea level static thrust, which are estimated based on the Boeing 747. In this case, the sea level static thrust is about 25% low.

The step variable during the takeoff is ground speed in 10 knot increments. During the takeoff, velocity, thrust, and drag are changing rapidly. By using ground speed as the integration variable, the time between nodes is about 2 seconds. This gives good accuracy during the takeoff.

### Climb

The next three tables show trajectory state data for the climb profile which extends from liftoff to top of climb including the acceleration to cruise speed. Two turns occur during the climb.

| Elapsed Time | Range | Fuel Burn | Altitude | TAS | IAS | | | Climb Rate |
|---|---|---|---|---|---|---|---|---|
| [h:mm:ss.000] | [nmi] | [lbs] | [ft] | [knots] | [knots] | Mach | Nx | [fpm] |
| 0:10:24.710 | 0.902 | 2142.7 | 0 | 146.40 | 146.40 | 0.2212 | 0.1766 | 0 |
| 0:10:27.475 | 0.985 | 2173.6 | 69 | 150.00 | 149.85 | 0.2267 | 0.1684 | 1,515 |
| 0:10:35.053 | 1.227 | 2257.8 | 268 | 160.00 | 159.38 | 0.2420 | 0.1713 | 1,645 |
| 0:10:42.535 | 1.487 | 2340.0 | 481 | 170.00 | 168.83 | 0.2573 | 0.1728 | 1,763 |
| 0:10:49.981 | 1.766 | 2420.9 | 706 | 180.00 | 178.19 | 0.2727 | 0.1730 | 1,869 |
| 0:10:57.439 | 2.067 | 2501.0 | 944 | 190.00 | 187.45 | 0.2881 | 0.1723 | 1,964 |
| 0:11:04.947 | 2.391 | 2580.7 | 1,195 | 200.00 | 196.61 | 0.3035 | 0.1707 | 2,049 |
| 0:11:12.539 | 2.740 | 2660.3 | 1,459 | 210.00 | 205.67 | 0.3189 | 0.1685 | 2,124 |
| 0:11:20.244 | 3.116 | 2740.0 | 1,736 | 220.00 | 214.63 | 0.3345 | 0.1658 | 2,188 |
| 0:11:28.088 | 3.521 | 2820.2 | 2,026 | 230.00 | 223.47 | 0.3500 | 0.1625 | 2,243 |
| 0:11:36.100 | 3.957 | 2901.0 | 2,329 | 240.00 | 232.20 | 0.3656 | 0.1589 | 2,289 |
| 0:11:44.305 | 4.426 | 2982.6 | 2,644 | 250.00 | 240.81 | 0.3813 | 0.1550 | 2,325 |
| 0:11:52.729 | 4.932 | 3065.2 | 2,972 | 260.00 | 249.31 | 0.3970 | 0.1508 | 2,352 |
| 0:11:53.432 | 4.975 | 3072.1 | 3,000 | 260.82 | 250.00 | 0.3983 | 0.1504 | 2,354 |
| 0:12:09.971 | 6.001 | 3231.2 | 4,000 | 264.57 | 250.00 | 0.4054 | 0.1458 | 3,593 |
| 0:12:26.881 | 7.065 | 3390.1 | 5,000 | 268.40 | 250.00 | 0.4128 | 0.1409 | 3,514 |
| 0:12:44.182 | 8.172 | 3549.0 | 6,000 | 272.30 | 250.00 | 0.4203 | 0.1361 | 3,433 |
| 0:13:01.901 | 9.327 | 3707.9 | 7,000 | 276.28 | 250.00 | 0.4279 | 0.1313 | 3,350 |
| 0:13:20.069 | 10.532 | 3867.0 | 8,000 | 280.34 | 250.00 | 0.4358 | 0.1265 | 3,265 |
| 0:13:38.719 | 11.792 | 4026.3 | 9,000 | 284.48 | 250.00 | 0.4438 | 0.1218 | 3,179 |
| 0:13:57.888 | 13.109 | 4185.9 | 10,000 | 288.70 | 250.00 | 0.4521 | 0.1171 | 3,091 |
| 0:13:59.225 | 13.202 | 4196.9 | 10,043 | 290.00 | 250.98 | 0.4542 | 0.1164 | 1,927 |
| 0:14:09.649 | 13.946 | 4282.2 | 10,381 | 300.00 | 258.46 | 0.4704 | 0.1144 | 1,960 |
| 0:14:20.265 | 14.733 | 4368.8 | 10,730 | 310.00 | 265.83 | 0.4868 | 0.1122 | 1,986 |
| 0:14:31.099 | 15.567 | 4456.7 | 11,090 | 320.00 | 273.09 | 0.5031 | 0.1098 | 2,007 |
| 0:14:42.179 | 16.451 | 4546.1 | 11,462 | 330.00 | 280.23 | 0.5196 | 0.1073 | 2,022 |
| 0:14:53.530 | 17.388 | 4637.2 | 11,846 | 340.00 | 287.26 | 0.5361 | 0.1046 | 2,031 |
| 0:14:58.085 | 17.773 | 4673.6 | 12,000 | 343.94 | 290.00 | 0.5426 | 0.1035 | 2,034 |
| 0:15:17.505 | 19.437 | 4827.0 | 13,000 | 349.02 | 290.00 | 0.5527 | 0.0999 | 3,054 |
| 0:15:37.477 | 21.176 | 4981.3 | 14,000 | 354.19 | 290.00 | 0.5630 | 0.0961 | 2,969 |
| 0:15:58.040 | 22.996 | 5136.7 | 15,000 | 359.46 | 290.00 | 0.5736 | 0.0923 | 2,881 |
| 0:16:19.245 | 24.904 | 5293.2 | 16,000 | 364.83 | 290.00 | 0.5844 | 0.0886 | 2,792 |
| 0:16:41.149 | 26.910 | 5451.2 | 17,000 | 370.31 | 290.00 | 0.5955 | 0.0848 | 2,701 |
| 0:17:03.817 | 29.021 | 5610.7 | 18,000 | 375.89 | 290.00 | 0.6068 | 0.0811 | 2,607 |
| 0:17:27.321 | 31.247 | 5772.1 | 19,000 | 381.58 | 290.00 | 0.6184 | 0.0774 | 2,512 |
| 0:17:27.874 | 31.300 | 5775.9 | 19,023 | 381.71 | 290.00 | 0.6187 | 0.0773 | 2,503 |
| 0:17:28.357 | 31.346 | 5779.1 | 19,043 | 381.83 | 290.00 | 0.6189 | 0.0754 | 2,441 |
| 0:17:30.059 | 31.509 | 5790.7 | 19,112 | 382.22 | 290.00 | 0.6198 | 0.0751 | 2,434 |
| 0:17:36.090 | 32.090 | 5831.3 | 19,356 | 383.63 | 290.00 | 0.6226 | 0.0742 | 2,412 |
| 0:17:40.477 | 32.517 | 5860.7 | 19,531 | 384.64 | 290.00 | 0.6247 | 0.0736 | 2,394 |
| 0:17:45.462 | 33.011 | 5894.0 | 19,729 | 385.79 | 290.00 | 0.6271 | 0.0728 | 2,375 |
| 0:17:50.177 | 33.485 | 5925.3 | 19,915 | 386.88 | 290.00 | 0.6293 | 0.0721 | 2,356 |
| 0:17:54.968 | 33.975 | 5957.0 | 20,102 | 387.97 | 290.00 | 0.6316 | 0.0714 | 2,338 |
| 0:17:59.691 | 34.467 | 5988.0 | 20,285 | 389.05 | 290.00 | 0.6338 | 0.0708 | 2,320 |
| 0:18:04.408 | 34.967 | 6018.9 | 20,467 | 390.12 | 290.00 | 0.6360 | 0.0701 | 2,302 |
| 0:18:09.092 | 35.472 | 6049.4 | 20,646 | 391.18 | 290.00 | 0.6382 | 0.0694 | 2,284 |
| 0:18:13.754 | 35.984 | 6079.6 | 20,823 | 392.23 | 290.00 | 0.6403 | 0.0688 | 2,266 |
| 0:18:18.388 | 36.502 | 6109.5 | 20,997 | 393.26 | 290.00 | 0.6425 | 0.0681 | 2,248 |
| 0:18:22.998 | 37.026 | 6139.1 | 21,169 | 394.29 | 290.00 | 0.6446 | 0.0675 | 2,231 |
| 0:18:27.581 | 37.556 | 6168.4 | 21,338 | 395.31 | 290.00 | 0.6467 | 0.0669 | 2,214 |
| 0:18:30.870 | 37.942 | 6189.4 | 21,459 | 396.03 | 290.00 | 0.6482 | 0.0664 | 2,201 |
| 0:18:45.585 | 39.697 | 6282.3 | 22,000 | 399.30 | 290.00 | 0.6550 | 0.0663 | 2,212 |
| 0:19:13.405 | 43.063 | 6454.2 | 23,000 | 405.44 | 290.00 | 0.6677 | 0.0627 | 2,112 |
| 0:19:42.634 | 46.651 | 6629.8 | 24,000 | 411.69 | 290.00 | 0.6808 | 0.0590 | 2,007 |
| 0:20:13.451 | 50.489 | 6809.7 | 25,000 | 418.05 | 290.00 | 0.6942 | 0.0554 | 1,900 |
| 0:20:46.071 | 54.610 | 6994.5 | 26,000 | 424.54 | 290.00 | 0.7079 | 0.0517 | 1,791 |
| 0:21:20.758 | 59.057 | 7185.1 | 27,000 | 431.15 | 290.00 | 0.7220 | 0.0481 | 1,680 |
| 0:21:57.831 | 63.879 | 7382.4 | 28,000 | 437.88 | 290.00 | 0.7364 | 0.0445 | 1,568 |
| 0:22:06.277 | 64.987 | 7426.5 | 28,218 | 439.36 | 290.00 | 0.7396 | 0.0437 | 1,539 |
| 0:22:14.259 | 66.038 | 7467.8 | 28,419 | 440.74 | 290.00 | 0.7425 | 0.0422 | 1,488 |
| 0:22:19.279 | 66.698 | 7493.7 | 28,543 | 441.59 | 290.00 | 0.7443 | 0.0418 | 1,473 |
| 0:22:24.157 | 67.335 | 7518.7 | 28,662 | 442.41 | 290.00 | 0.7461 | 0.0413 | 1,459 |
| 0:22:29.141 | 67.984 | 7544.2 | 28,783 | 443.24 | 290.00 | 0.7479 | 0.0409 | 1,446 |
| 0:22:33.832 | 68.592 | 7568.1 | 28,895 | 444.01 | 290.00 | 0.7495 | 0.0405 | 1,433 |
| 0:22:38.891 | 69.246 | 7593.8 | 29,016 | 444.84 | 290.00 | 0.7513 | 0.0401 | 1,419 |
| 0:22:43.205 | 69.800 | 7615.6 | 29,117 | 445.55 | 290.00 | 0.7529 | 0.0397 | 1,407 |
| 0:22:48.685 | 70.501 | 7643.2 | 29,245 | 446.43 | 290.00 | 0.7548 | 0.0392 | 1,392 |
| 0:22:51.996 | 70.923 | 7659.8 | 29,321 | 446.97 | 290.00 | 0.7559 | 0.0390 | 1,383 |
| 0:22:59.075 | 71.821 | 7695.1 | 29,484 | 448.10 | 290.00 | 0.7584 | 0.0384 | 1,365 |
| 0:22:59.167 | 71.833 | 7695.6 | 29,486 | 448.11 | 290.00 | 0.7584 | 0.0384 | 1,364 |
| 0:23:01.796 | 72.163 | 7708.7 | 29,545 | 448.53 | 290.00 | 0.7593 | 0.0382 | 1,357 |
| 0:23:22.089 | 74.718 | 7808.8 | 30,000 | 451.72 | 290.00 | 0.7662 | 0.0373 | 1,335 |
| 0:24:04.035 | 80.047 | 8010.8 | 30,895 | 458.07 | 290.00 | 0.7800 | 0.0341 | 1,232 |
| 0:24:07.712 | 80.517 | 8028.2 | 31,000 | 457.86 | 289.33 | 0.7800 | 0.0339 | 1,710 |
| 0:24:44.338 | 85.190 | 8197.6 | 32,000 | 455.86 | 283.02 | 0.7800 | 0.0312 | 1,567 |
| 0:25:24.522 | 90.294 | 8376.2 | 33,000 | 453.84 | 276.79 | 0.7800 | 0.0284 | 1,419 |
| 0:26:09.180 | 95.943 | 8566.4 | 34,000 | 451.82 | 270.62 | 0.7800 | 0.0255 | 1,268 |
| 0:26:59.621 | 102.297 | 8772.0 | 35,000 | 449.79 | 264.53 | 0.7800 | 0.0224 | 1,111 |
| 0:27:57.818 | 109.596 | 8998.6 | 36,000 | 447.75 | 258.52 | 0.7800 | 0.0193 | 951 |
| 0:29:12.346 | 118.922 | 9275.4 | 37,000 | 447.57 | 252.60 | 0.7800 | 0.0160 | 730 |
| 0:29:20.344 | 119.926 | 9304.4 | 37,000 | 450.00 | 254.12 | 0.7842 | 0.0159 | 0 |
| 0:29:50.440 | 123.752 | 9413.7 | 37,000 | 459.04 | 259.79 | 0.8000 | 0.0156 | 0 |

| Elapsed Time | Weight | Lift | Thrust | Drag | Alpha | Gamma | Latitude | Longitude |
|---|---|---|---|---|---|---|---|---|
| [h:mm:ss.000] | [lbs] | [lbs] | [lbs] | [lbs] | [degrees] | [degrees] | [degrees] | [degrees] |
| 0:10:24.710 | 328,551 | 0 | 82,417 | 7,966 | 0.00 | 0.00 | 37.621 | −122.361 |
| 0:10:27.475 | 328,520 | 303,240 | 82,006 | 23,213 | 16.75 | 5.73 | 37.622 | −122.359 |
| 0:10:35.053 | 328,436 | 305,891 | 80,857 | 21,848 | 14.94 | 5.83 | 37.625 | −122.356 |
| 0:10:42.535 | 328,353 | 308,136 | 79,698 | 20,787 | 13.42 | 5.88 | 37.628 | −122.352 |
| 0:10:49.981 | 328,272 | 310,053 | 78,530 | 19,981 | 12.12 | 5.88 | 37.632 | −122.348 |
| 0:10:57.439 | 328,192 | 311,700 | 77,353 | 19,390 | 11.01 | 5.86 | 37.635 | −122.343 |
| 0:11:04.947 | 328,113 | 313,125 | 76,169 | 18,981 | 10.06 | 5.81 | 37.639 | −122.339 |
| 0:11:12.539 | 328,033 | 314,365 | 74,979 | 18,727 | 9.23 | 5.73 | 37.643 | −122.333 |
| 0:11:20.244 | 327,953 | 315,449 | 73,782 | 18,606 | 8.51 | 5.64 | 37.647 | −122.328 |
| 0:11:28.088 | 327,873 | 316,402 | 72,581 | 18,601 | 7.88 | 5.53 | 37.652 | −122.322 |
| 0:11:36.100 | 327,792 | 317,243 | 71,374 | 18,695 | 7.32 | 5.40 | 37.657 | −122.315 |
| 0:11:44.305 | 327,711 | 317,988 | 70,165 | 18,875 | 6.82 | 5.27 | 37.663 | −122.308 |
| 0:11:52.729 | 327,628 | 318,650 | 68,952 | 19,130 | 6.39 | 5.13 | 37.669 | −122.301 |
| 0:11:53.432 | 327,621 | 318,701 | 68,852 | 19,154 | 6.35 | 5.11 | 37.669 | −122.300 |
| 0:12:09.971 | 327,462 | 317,095 | 67,225 | 19,072 | 6.33 | 7.71 | 37.681 | −122.285 |
| 0:12:26.881 | 327,303 | 317,310 | 65,607 | 19,077 | 6.34 | 7.43 | 37.694 | −122.269 |
| 0:12:44.182 | 327,144 | 317,515 | 63,999 | 19,080 | 6.36 | 7.15 | 37.707 | −122.252 |
| 0:13:01.901 | 326,985 | 317,710 | 62,402 | 19,083 | 6.37 | 6.88 | 37.721 | −122.235 |
| 0:13:20.069 | 326,826 | 317,894 | 60,815 | 19,085 | 6.38 | 6.60 | 37.735 | −122.217 |
| 0:13:38.719 | 326,667 | 318,069 | 59,239 | 19,087 | 6.40 | 6.34 | 37.750 | −122.198 |
| 0:13:57.888 | 326,507 | 318,234 | 57,673 | 19,088 | 6.41 | 6.07 | 37.765 | −122.179 |
| 0:13:59.225 | 326,497 | 319,390 | 57,535 | 19,173 | 6.39 | 3.76 | 37.766 | −122.177 |
| 0:14:09.649 | 326,411 | 319,723 | 57,102 | 19,441 | 6.04 | 3.70 | 37.775 | −122.166 |
| 0:14:20.265 | 326,325 | 320,020 | 56,654 | 19,754 | 5.72 | 3.63 | 37.784 | −122.154 |
| 0:14:31.099 | 326,237 | 320,285 | 56,193 | 20,105 | 5.44 | 3.55 | 37.794 | −122.142 |
| 0:14:42.179 | 326,147 | 320,521 | 55,717 | 20,490 | 5.18 | 3.47 | 37.804 | −122.129 |
| 0:14:53.530 | 326,056 | 320,731 | 55,227 | 20,904 | 4.94 | 3.38 | 37.815 | −122.115 |
| 0:14:58.085 | 326,020 | 320,807 | 55,030 | 21,074 | 4.85 | 3.35 | 37.820 | −122.109 |
| 0:15:17.505 | 325,866 | 320,097 | 53,756 | 21,022 | 4.86 | 4.96 | 37.840 | −122.084 |
| 0:15:37.477 | 325,712 | 320,138 | 52,484 | 20,997 | 4.87 | 4.75 | 37.860 | −122.058 |
| 0:15:58.040 | 325,557 | 320,173 | 51,217 | 20,971 | 4.89 | 4.54 | 37.881 | −122.031 |
| 0:16:19.245 | 325,400 | 320,202 | 49,952 | 20,944 | 4.90 | 4.33 | 37.904 | −122.002 |
| 0:16:41.149 | 325,242 | 320,224 | 48,691 | 20,915 | 4.92 | 4.13 | 37.927 | −121.972 |
| 0:17:03.817 | 325,083 | 320,240 | 47,433 | 20,886 | 4.93 | 3.93 | 37.952 | −121.940 |
| 0:17:27.321 | 324,921 | 320,248 | 46,179 | 20,854 | 4.95 | 3.73 | 37.978 | −121.907 |
| 0:17:27.874 | 324,918 | 320,252 | 46,150 | 20,854 | 4.95 | 3.71 | 37.979 | −121.906 |
| 0:17:28.357 | 324,914 | 335,840 | 46,125 | 21,446 | 5.19 | 3.62 | 37.979 | −121.905 |
| 0:17:30.059 | 324,903 | 335,839 | 46,039 | 21,444 | 5.19 | 3.61 | 37.981 | −121.903 |
| 0:17:36.090 | 324,862 | 335,838 | 45,734 | 21,436 | 5.20 | 3.56 | 37.987 | −121.893 |
| 0:17:40.477 | 324,833 | 335,838 | 45,514 | 21,431 | 5.20 | 3.52 | 37.991 | −121.885 |
| 0:17:45.462 | 324,799 | 335,836 | 45,267 | 21,425 | 5.21 | 3.48 | 37.994 | −121.876 |
| 0:17:50.177 | 324,768 | 335,835 | 45,034 | 21,419 | 5.21 | 3.45 | 37.997 | −121.866 |
| 0:17:54.968 | 324,736 | 335,834 | 44,800 | 21,413 | 5.21 | 3.41 | 37.998 | −121.856 |
| 0:17:59.691 | 324,705 | 335,832 | 44,572 | 21,408 | 5.22 | 3.38 | 37.999 | −121.846 |
| 0:18:04.408 | 324,675 | 335,830 | 44,345 | 21,402 | 5.22 | 3.34 | 37.999 | −121.835 |
| 0:18:09.092 | 324,644 | 335,827 | 44,122 | 21,396 | 5.22 | 3.30 | 37.997 | −121.825 |
| 0:18:13.754 | 324,614 | 335,825 | 43,902 | 21,391 | 5.23 | 3.27 | 37.995 | −121.814 |
| 0:18:18.388 | 324,584 | 335,822 | 43,685 | 21,385 | 5.23 | 3.24 | 37.992 | −121.804 |
| 0:18:22.998 | 324,554 | 335,819 | 43,470 | 21,379 | 5.23 | 3.20 | 37.988 | −121.795 |
| 0:18:27.581 | 324,525 | 335,816 | 43,259 | 21,374 | 5.24 | 3.17 | 37.982 | −121.786 |
| 0:18:30.870 | 324,504 | 335,814 | 43,109 | 21,370 | 5.24 | 3.15 | 37.978 | −121.780 |
| 0:18:45.585 | 324,411 | 320,221 | 42,436 | 20,753 | 5.01 | 3.14 | 37.957 | −121.753 |
| 0:19:13.405 | 324,239 | 320,200 | 41,196 | 20,716 | 5.03 | 2.95 | 37.918 | −121.703 |
| 0:19:42.634 | 324,064 | 320,171 | 39,958 | 20,678 | 5.05 | 2.76 | 37.875 | −121.650 |
| 0:20:13.451 | 323,884 | 320,134 | 38,724 | 20,638 | 5.07 | 2.57 | 37.830 | −121.593 |
| 0:20:46.071 | 323,699 | 320,088 | 37,494 | 20,597 | 5.09 | 2.39 | 37.781 | −121.531 |
| 0:21:20.758 | 323,508 | 320,033 | 36,267 | 20,554 | 5.12 | 2.21 | 37.729 | −121.465 |
| 0:21:57.831 | 323,311 | 319,967 | 35,043 | 20,510 | 5.14 | 2.03 | 37.671 | −121.394 |
| 0:22:06.277 | 323,267 | 319,952 | 34,776 | 20,500 | 5.15 | 1.98 | 37.658 | −121.377 |
| 0:22:14.259 | 323,226 | 326,404 | 34,531 | 20,743 | 5.26 | 1.91 | 37.647 | −121.361 |
| 0:22:19.279 | 323,200 | 326,394 | 34,380 | 20,737 | 5.26 | 1.89 | 37.640 | −121.350 |
| 0:22:24.157 | 323,175 | 326,383 | 34,234 | 20,732 | 5.27 | 1.87 | 37.634 | −121.339 |
| 0:22:29.141 | 323,149 | 326,373 | 34,087 | 20,726 | 5.27 | 1.85 | 37.628 | −121.327 |
| 0:22:33.832 | 323,125 | 326,363 | 33,950 | 20,721 | 5.27 | 1.83 | 37.624 | −121.316 |
| 0:22:38.891 | 323,100 | 326,352 | 33,803 | 20,716 | 5.27 | 1.80 | 37.619 | −121.303 |
| 0:22:43.205 | 323,078 | 326,343 | 33,680 | 20,711 | 5.28 | 1.79 | 37.616 | −121.292 |
| 0:22:48.685 | 323,050 | 326,331 | 33,524 | 20,705 | 5.28 | 1.76 | 37.613 | −121.278 |
| 0:22:51.996 | 323,034 | 326,324 | 33,431 | 20,702 | 5.28 | 1.75 | 37.611 | −121.269 |
| 0:22:59.075 | 322,998 | 326,308 | 33,234 | 20,694 | 5.29 | 1.72 | 37.608 | −121.251 |
| 0:22:59.167 | 322,998 | 326,308 | 33,231 | 20,694 | 5.29 | 1.72 | 37.608 | −121.251 |
| 0:23:01.796 | 322,985 | 326,302 | 33,159 | 20,691 | 5.29 | 1.71 | 37.608 | −121.244 |
| 0:23:22.089 | 322,885 | 319,794 | 32,605 | 20,415 | 5.20 | 1.67 | 37.603 | −121.190 |
| 0:24:04.035 | 322,683 | 319,700 | 31,519 | 20,371 | 5.22 | 1.52 | 37.594 | −121.079 |
| 0:24:07.712 | 322,665 | 319,576 | 31,392 | 20,328 | 5.25 | 2.11 | 37.593 | −121.069 |
| 0:24:44.338 | 322,496 | 319,422 | 30,182 | 19,985 | 5.49 | 1.94 | 37.584 | −120.971 |
| 0:25:24.522 | 322,317 | 319,261 | 28,975 | 19,681 | 5.75 | 1.77 | 37.575 | −120.865 |
| 0:26:09.180 | 322,127 | 319,090 | 27,771 | 19,417 | 6.02 | 1.59 | 37.564 | −120.747 |
| 0:26:59.621 | 321,921 | 318,905 | 26,571 | 19,193 | 6.31 | 1.40 | 37.552 | −120.614 |
| 0:27:57.818 | 321,695 | 318,701 | 25,374 | 19,008 | 6.62 | 1.20 | 37.538 | −120.461 |
| 0:29:12.346 | 321,418 | 318,456 | 24,181 | 18,863 | 6.94 | 0.92 | 37.520 | −120.267 |
| 0:29:20.344 | 321,389 | 318,500 | 24,181 | 18,891 | 6.86 | 0.00 | 37.518 | −120.246 |
| 0:29:50.440 | 321,280 | 318,503 | 24,181 | 19,006 | 6.59 | 0.00 | 37.511 | −120.166 |

| Elapsed Time | Ground Speed | True Course | Heading | Roll Angle |
|---|---|---|---|---|
| [h:mm:ss.000] | [knots] | [degrees] | [degrees] | [degrees] |
| 0:10:24.710 | 106.71 | 45.00 | 45.00 | 0.00 |
| 0:10:27.475 | 109.65 | 45.00 | 31.30 | 0.00 |
| 0:10:35.053 | 119.84 | 45.00 | 32.17 | 0.00 |
| 0:10:42.535 | 130.02 | 45.01 | 32.94 | 0.00 |
| 0:10:49.981 | 140.18 | 45.01 | 33.62 | 0.00 |
| 0:10:57.439 | 150.32 | 45.01 | 34.23 | 0.00 |
| 0:11:04.947 | 160.46 | 45.01 | 34.78 | 0.00 |
| 0:11:12.539 | 170.59 | 45.02 | 35.27 | 0.00 |
| 0:11:20.244 | 180.72 | 45.02 | 35.72 | 0.00 |
| 0:11:28.088 | 190.84 | 45.02 | 36.14 | 0.00 |
| 0:11:36.100 | 200.96 | 45.03 | 36.51 | 0.00 |
| 0:11:44.305 | 211.08 | 45.03 | 36.86 | 0.00 |
| 0:11:52.729 | 221.20 | 45.04 | 37.18 | 0.00 |
| 0:11:53.432 | 222.03 | 45.04 | 37.21 | 0.00 |
| 0:12:09.971 | 224.46 | 45.04 | 37.29 | 0.00 |
| 0:12:26.881 | 228.46 | 45.05 | 37.41 | 0.00 |
| 0:12:44.182 | 232.54 | 45.06 | 37.53 | 0.00 |
| 0:13:01.901 | 236.69 | 45.07 | 37.65 | 0.00 |
| 0:13:20.069 | 240.91 | 45.08 | 37.78 | 0.00 |
| 0:13:38.719 | 245.22 | 45.09 | 37.90 | 0.00 |
| 0:13:57.888 | 249.60 | 45.10 | 38.02 | 0.00 |
| 0:13:59.225 | 251.91 | 45.11 | 38.08 | 0.00 |
| 0:14:09.649 | 261.99 | 45.12 | 38.32 | 0.00 |
| 0:14:20.265 | 272.06 | 45.12 | 38.55 | 0.00 |
| 0:14:31.099 | 282.14 | 45.13 | 38.76 | 0.00 |
| 0:14:42.179 | 292.21 | 45.14 | 38.96 | 0.00 |
| 0:14:53.530 | 302.29 | 45.15 | 39.15 | 0.00 |
| 0:14:58.085 | 306.26 | 45.15 | 39.23 | 0.00 |
| 0:15:17.505 | 310.64 | 45.16 | 39.31 | 0.00 |
| 0:15:37.477 | 315.94 | 45.17 | 39.41 | 0.00 |
| 0:15:58.040 | 321.33 | 45.19 | 39.51 | 0.00 |
| 0:16:19.245 | 326.83 | 45.21 | 39.61 | 0.00 |
| 0:16:41.149 | 332.42 | 45.22 | 39.71 | 0.00 |
| 0:17:03.817 | 338.12 | 45.24 | 39.81 | 0.00 |
| 0:17:27.321 | 343.92 | 45.26 | 39.91 | 0.00 |
| 0:17:27.874 | 344.10 | 45.33 | 39.98 | 0.00 |
| 0:17:28.357 | 344.55 | 45.86 | 40.46 | 17.51 |
| 0:17:30.059 | 345.77 | 47.28 | 41.75 | 17.51 |
| 0:17:36.090 | 350.26 | 52.30 | 46.37 | 17.51 |
| 0:17:40.477 | 355.84 | 59.11 | 52.69 | 17.51 |
| 0:17:45.462 | 361.52 | 65.33 | 58.55 | 17.51 |
| 0:17:50.177 | 367.68 | 71.87 | 64.80 | 17.51 |
| 0:17:54.968 | 374.11 | 78.39 | 71.12 | 17.51 |
| 0:17:59.691 | 380.83 | 85.02 | 77.65 | 17.51 |
| 0:18:04.408 | 387.74 | 91.72 | 84.35 | 17.51 |
| 0:18:09.092 | 394.78 | 98.51 | 91.23 | 17.51 |
| 0:18:13.754 | 401.87 | 105.38 | 98.31 | 17.51 |
| 0:18:18.388 | 408.91 | 112.34 | 105.58 | 17.51 |
| 0:18:22.998 | 415.79 | 119.38 | 113.03 | 17.51 |
| 0:18:27.581 | 422.40 | 126.51 | 120.66 | 17.51 |
| 0:18:30.870 | 427.63 | 132.69 | 127.36 | 17.51 |
| 0:18:45.585 | 432.52 | 135.04 | 129.96 | 0.00 |
| 0:19:13.405 | 438.74 | 135.06 | 130.05 | 0.00 |
| 0:19:42.634 | 445.10 | 135.09 | 130.16 | 0.00 |
| 0:20:13.451 | 451.57 | 135.12 | 130.27 | 0.00 |
| 0:20:46.071 | 458.15 | 135.15 | 130.39 | 0.00 |
| 0:21:20.758 | 464.86 | 135.19 | 130.50 | 0.00 |
| 0:21:57.831 | 471.68 | 135.23 | 130.62 | 0.00 |
| 0:22:06.277 | 473.21 | 135.27 | 130.68 | 0.00 |
| 0:22:14.259 | 472.59 | 132.30 | 127.49 | −11.42 |
| 0:22:19.279 | 470.10 | 127.64 | 122.49 | −11.42 |
| 0:22:24.157 | 468.26 | 124.10 | 118.73 | −11.42 |
| 0:22:29.141 | 466.35 | 120.59 | 115.01 | −11.42 |
| 0:22:33.832 | 464.37 | 117.16 | 111.41 | −11.42 |
| 0:22:38.891 | 462.37 | 113.72 | 107.81 | −11.42 |
| 0:22:43.205 | 460.31 | 110.42 | 104.39 | −11.42 |
| 0:22:48.685 | 458.27 | 107.00 | 100.85 | −11.42 |
| 0:22:51.996 | 456.16 | 103.94 | 97.70 | −11.42 |
| 0:22:59.075 | 454.15 | 100.33 | 94.03 | −11.42 |
| 0:22:59.167 | 452.00 | 97.86 | 91.51 | −11.42 |
| 0:23:01.796 | 451.60 | 96.93 | 90.57 | −11.42 |
| 0:23:22.089 | 454.12 | 96.13 | 89.81 | 0.00 |
| 0:24:04.035 | 460.58 | 96.17 | 89.93 | 0.00 |
| 0:24:07.712 | 460.27 | 96.24 | 90.00 | 0.00 |
| 0:24:44.338 | 458.31 | 96.24 | 89.98 | 0.00 |
| 0:25:24.522 | 456.38 | 96.30 | 90.01 | 0.00 |
| 0:26:09.180 | 454.45 | 96.37 | 90.05 | 0.00 |
| 0:26:59.621 | 452.51 | 96.44 | 90.09 | 0.00 |
| 0:27:57.818 | 450.56 | 96.52 | 90.15 | 0.00 |
| 0:29:12.346 | 450.50 | 96.61 | 90.24 | 0.00 |
| 0:29:20.344 | 453.11 | 96.73 | 90.39 | 0.00 |
| 0:29:50.440 | 462.22 | 96.74 | 90.53 | 0.00 |

The first part of the climb profile is a climbing acceleration to 3000 feet AGL and 250 knots indicated. The climb rate increases from 1515 fpm to 2354 fpm even though the flight path angle is declining because of reducing specific excess thrust (nₓ). Because the acceleration requires energy, the climb rate is somewhat diminished over that of the next constant CAS climb. This is reflected in the jump from 2354 fpm to 3593 fpm at the start of the 250 knot constant CAS segment.

Note that the specific excess thrust (nₓ) steadily decreases from takeoff to cruise, reaching a minimum of 0.0156 at 37,000 feet.

Upon reaching 10,000 feet, the aircraft performs a climbing acceleration to 12,000 feet and 290 knots, the ideal climb CAS for the B767-300. Again the climb rate drops because of the energy required for acceleration. This is reflected in the jump in climb rate at 12,000 feet from 2034 fpm to 3054 fpm.

The next vertical segment is a constant CAS climb to the transition altitude of 30,895. During this segment there is a turn from about 45 degrees true course to 135 degrees. During the turn, the altitude step drops to provide approximately 5 degrees of turn between point mass nodes. The original step size resumes when the turn is complete.

The effect of the turn on the solution of the point mass equations can be seen near the bottom of page 8. The aircraft banks to the right 17.5 degrees (page 10). The lift, which had been slightly less than the weight jumps from 320,000 pounds to 336,000 pounds while the weight remains almost constant at 325,000 pounds. The increase in lift causes an increase drag, from 20,854 pounds to 21,446 pounds. Since the thrust is already at maximum, there is a slight drop in the flight path angle.

There is a second turn during the constant CAS portion of the climb that starts at 28,218 feet and finishes at 29,545. This time the turn is to the left with a bank angle of −11.4 degrees. The bank angles are determined from a shape function that is solely a function of turn angle. This function is based on data from Hunter, George: Aircraft Flight Dynamics in the Memphis TRACON. Seagull Technology TM 92120-01, January 1992 and Hunter, George: Turn Dynamics in the Dallas-Ft. Worth TRACON. Seagull Technology TM 93120-01, February 1993.

The next vertical segment is a climb at a constant Mach of 0.78 to 37,000 feet. Since the desired cruise is at Mach 0.80, this is followed by a short level flight acceleration.

Through out the climb portion of the trajectory, the aircraft is flown at full throttle. The time, range, and fuel burn at waypoints is determined by integrating the trajectory in the vertical profile and performing iterations to determine the start and end of turns.

The time between point mass nodes varies from 15 to 20 seconds in the climb when not in a turn. During turns the time between nodes drops to 5 seconds.

### Cruise

The next three tables show trajectory state data for the cruise which extends from top of climb to top of descent. This excludes the acceleration and deceleration in level flight to adjust for the climb and descent Mach. One turn occurs during the cruise.

| Elapsed Time | Range | Fuel Burn | Altitude | TAS | IAS | | | Climb Rate |
|---|---|---|---|---|---|---|---|---|
| [h:mm:ss.000] | [nmi] | [lbs] | [ft] | [knots] | [knots] | Mach | Nx | [fpm] |
| 0:29:50.440 | 123.752 | 9413.7 | 37,000 | 459.04 | 259.79 | 0.8000 | 0.0156 | 0 |
| 0:39:44.242 | 200.000 | 11121.0 | 37,000 | 459.04 | 259.79 | 0.8000 | 0.0000 | 0 |
| 0:52:42.307 | 300.000 | 13347.0 | 37,000 | 459.04 | 259.79 | 0.8000 | 0.0000 | 0 |
| 1:05:38.739 | 400.000 | 15555.6 | 37,000 | 459.04 | 259.79 | 0.8000 | 0.0000 | 0 |
| 1:18:33.348 | 500.000 | 17746.4 | 37,000 | 459.04 | 259.79 | 0.8000 | 0.0000 | 0 |
| 1:31:26.170 | 600.000 | 19919.7 | 37,000 | 459.04 | 259.79 | 0.8000 | 0.0000 | 0 |
| 1:44:17.242 | 700.000 | 22076.0 | 37,000 | 459.04 | 259.79 | 0.8000 | 0.0000 | 0 |
| 1:57:06.608 | 800.000 | 24215.6 | 37,000 | 459.04 | 259.79 | 0.8000 | 0.0000 | 0 |
| 2:09:54.310 | 900.000 | 26338.8 | 37,000 | 459.04 | 259.79 | 0.8000 | 0.0000 | 0 |
| 2:22:40.393 | 1000.000 | 28446.1 | 37,000 | 459.04 | 259.79 | 0.8000 | 0.0000 | 0 |
| 2:35:24.907 | 1100.000 | 30537.6 | 37,000 | 459.04 | 259.79 | 0.8000 | 0.0000 | 0 |
| 2:48:07.898 | 1200.000 | 32613.8 | 37,000 | 459.04 | 259.79 | 0.8000 | 0.0000 | 0 |
| 2:58:29.447 | 1281.620 | 34296.9 | 37,000 | 459.04 | 259.79 | 0.8000 | 0.0000 | 0 |
| 2:58:31.669 | 1281.912 | 34303.0 | 37,000 | 459.04 | 259.79 | 0.8000 | 0.0000 | 0 |
| 2:58:40.077 | 1283.014 | 34326.2 | 37,000 | 459.04 | 259.79 | 0.8000 | 0.0000 | 0 |
| 2:58:48.549 | 1284.116 | 34349.6 | 37,000 | 459.04 | 259.79 | 0.8000 | 0.0000 | 0 |
| 2:58:57.101 | 1285.218 | 34373.3 | 37,000 | 459.04 | 259.79 | 0.8000 | 0.0000 | 0 |
| 2:59:05.733 | 1286.321 | 34397.1 | 37,000 | 459.04 | 259.79 | 0.8000 | 0.0000 | 0 |
| 2:59:14.449 | 1287.423 | 34421.2 | 37,000 | 459.04 | 259.79 | 0.8000 | 0.0000 | 0 |
| 2:59:23.247 | 1288.525 | 34445.5 | 37,000 | 459.04 | 259.79 | 0.8000 | 0.0000 | 0 |
| 2:59:32.129 | 1289.627 | 34470.0 | 37,000 | 459.04 | 259.79 | 0.8000 | 0.0000 | 0 |
| 2:59:41.094 | 1290.730 | 34494.8 | 37,000 | 459.04 | 259.79 | 0.8000 | 0.0000 | 0 |
| 2:59:50.140 | 1291.832 | 34519.8 | 37,000 | 459.04 | 259.79 | 0.8000 | 0.0000 | 0 |
| 2:59:59.265 | 1292.934 | 34544.9 | 37,000 | 459.04 | 259.79 | 0.8000 | 0.0000 | 0 |
| 3:00:01.580 | 1293.212 | 34551.3 | 37,000 | 459.04 | 259.79 | 0.8000 | 0.0000 | 0 |
| 3:00:58.333 | 1300.000 | 34706.3 | 37,000 | 459.04 | 259.79 | 0.8000 | 0.0000 | 0 |
| 3:14:54.725 | 1400.000 | 36957.5 | 37,000 | 459.04 | 259.79 | 0.8000 | 0.0000 | 0 |
| 3:28:50.440 | 1500.000 | 39193.9 | 37,000 | 459.04 | 259.79 | 0.8000 | 0.0000 | 0 |
| 3:42:44.849 | 1600.000 | 41414.2 | 37,000 | 459.04 | 259.79 | 0.8000 | 0.0000 | 0 |
| 3:56:37.886 | 1700.000 | 43618.4 | 37,000 | 459.04 | 259.79 | 0.8000 | 0.0000 | 0 |
| 4:10:29.481 | 1800.000 | 45806.5 | 37,000 | 459.04 | 259.79 | 0.8000 | 0.0000 | 0 |
| 4:24:19.563 | 1900.000 | 47978.5 | 37,000 | 459.04 | 259.79 | 0.8000 | 0.0000 | 0 |
| 4:38:08.060 | 2000.000 | 50134.5 | 37,000 | 459.04 | 259.79 | 0.8000 | 0.0000 | 0 |
| 4:51:54.899 | 2100.000 | 52274.5 | 37,000 | 459.04 | 259.79 | 0.8000 | 0.0000 | 0 |
| 5:05:40.007 | 2200.000 | 54398.6 | 37,000 | 459.04 | 259.79 | 0.8000 | 0.0000 | 0 |
| 5:19:23.310 | 2300.000 | 56506.8 | 37,000 | 459.04 | 259.79 | 0.8000 | 0.0000 | 0 |
| 5:33:04.735 | 2400.000 | 58599.1 | 37,000 | 459.04 | 259.79 | 0.8000 | 0.0000 | 0 |
| 5:45:38.162 | 2491.940 | 60508.6 | 37,000 | 459.04 | 259.79 | 0.8000 | 0.0000 | 0 |

| Elapsed Time | Weight | Lift | Thrust | Drag | Alpha | Gamma | Latitude | Longitude |
|---|---|---|---|---|---|---|---|---|
| [h:mm:ss.000] | [lbs] | [lbs] | [lbs] | [lbs] | [degrees] | [degrees] | [degrees] | [degrees] |
| 0:29:50.440 | 321,280 | 318,503 | 24,181 | 19,006 | 6.59 | 0.00 | 37.511 | −120.166 |
| 0:39:44.242 | 319,572 | 317,389 | 19,077 | 18,952 | 6.57 | 0.00 | 37.350 | −118.579 |
| 0:52:42.307 | 317,346 | 315,191 | 18,967 | 18,844 | 6.53 | 0.00 | 37.107 | −116.508 |
| 1:05:38.739 | 315,138 | 313,009 | 18,858 | 18,737 | 6.48 | 0.00 | 36.828 | −114.451 |
| 1:18:33.348 | 312,947 | 310,845 | 18,751 | 18,633 | 6.44 | 0.00 | 36.514 | −112.410 |
| 1:31:26.170 | 310,774 | 308,698 | 18,645 | 18,529 | 6.39 | 0.00 | 36.166 | −110.387 |
| 1:44:17.242 | 308,617 | 306,567 | 18,541 | 18,428 | 6.35 | 0.00 | 35.784 | −108.382 |
| 1:57:06.608 | 306,478 | 304,453 | 18,439 | 18,327 | 6.30 | 0.00 | 35.369 | −106.398 |
| 2:09:54.310 | 304,355 | 302,355 | 18,338 | 18,229 | 6.26 | 0.00 | 34.922 | −104.434 |
| 2:22:40.393 | 302,247 | 300,272 | 18,238 | 18,131 | 6.22 | 0.00 | 34.443 | −102.492 |
| 2:35:24.907 | 300,156 | 298,205 | 18,140 | 18,035 | 6.17 | 0.00 | 33.934 | −100.574 |
| 2:48:07.898 | 298,080 | 296,152 | 18,044 | 17,941 | 6.13 | 0.00 | 33.396 | −98.678 |
| 2:58:29.447 | 296,396 | 294,488 | 17,966 | 17,864 | 6.10 | 0.00 | 32.936 | −97.149 |
| 2:58:31.669 | 296,390 | 303,015 | 18,370 | 18,260 | 6.27 | 0.00 | 32.934 | −97.144 |
| 2:58:40.077 | 296,367 | 302,992 | 18,368 | 18,258 | 6.27 | 0.00 | 32.929 | −97.123 |
| 2:58:48.549 | 296,344 | 302,968 | 18,367 | 18,257 | 6.27 | 0.00 | 32.925 | −97.101 |
| 2:58:57.101 | 296,320 | 302,944 | 18,366 | 18,256 | 6.27 | 0.00 | 32.923 | −97.080 |
| 2:59:05.733 | 296,296 | 302,920 | 18,365 | 18,255 | 6.27 | 0.00 | 32.923 | −97.058 |
| 2:59:14.449 | 296,272 | 302,895 | 18,364 | 18,254 | 6.27 | 0.00 | 32.924 | −97.036 |
| 2:59:23.247 | 296,248 | 302,871 | 18,363 | 18,253 | 6.27 | 0.00 | 32.927 | −97.014 |
| 2:59:32.129 | 296,223 | 302,846 | 18,361 | 18,252 | 6.27 | 0.00 | 32.931 | −96.993 |
| 2:59:41.094 | 296,199 | 302,820 | 18,360 | 18,250 | 6.27 | 0.00 | 32.937 | −96.972 |
| 2:59:50.140 | 296,174 | 302,795 | 18,359 | 18,249 | 6.27 | 0.00 | 32.945 | −96.952 |
| 2:59:59.265 | 296,148 | 302,769 | 18,358 | 18,248 | 6.27 | 0.00 | 32.953 | −96.933 |
| 3:00:01.580 | 296,142 | 302,763 | 18,357 | 18,248 | 6.27 | 0.00 | 32.956 | −96.928 |
| 3:00:58.333 | 295,987 | 294,083 | 17,947 | 17,846 | 6.09 | 0.00 | 33.016 | −96.814 |
| 3:14:54.725 | 293,736 | 291,857 | 17,844 | 17,745 | 6.04 | 0.00 | 33.893 | −95.115 |
| 3:28:50.440 | 291,499 | 289,646 | 17,742 | 17,645 | 6.00 | 0.00 | 34.746 | −93.382 |
| 3:42:44.849 | 289,279 | 287,450 | 17,642 | 17,546 | 5.95 | 0.00 | 35.574 | −91.612 |
| 3:56:37.886 | 287,075 | 285,270 | 17,543 | 17,450 | 5.91 | 0.00 | 36.375 | −89.806 |
| 4:10:29.481 | 284,887 | 283,105 | 17,445 | 17,354 | 5.86 | 0.00 | 37.149 | −87.964 |
| 4:24:19.563 | 282,715 | 280,956 | 17,349 | 17,260 | 5.82 | 0.00 | 37.894 | −86.084 |
| 4:38:08.060 | 280,559 | 278,823 | 17,255 | 17,167 | 5.77 | 0.00 | 38.608 | −84.166 |
| 4:51:54.899 | 278,419 | 276,706 | 17,162 | 17,076 | 5.73 | 0.00 | 39.290 | −82.211 |
| 5:05:40.007 | 276,295 | 274,604 | 17,070 | 16,986 | 5.69 | 0.00 | 39.939 | −80.218 |
| 5:19:23.310 | 274,187 | 272,517 | 16,980 | 16,898 | 5.64 | 0.00 | 40.553 | −78.188 |
| 5:33:04.735 | 272,094 | 270,446 | 16,891 | 16,810 | 5.60 | 0.00 | 41.131 | −76.121 |
| 5:45:38.162 | 270,185 | 268,556 | 16,810 | 16,731 | 5.56 | 0.00 | 41.629 | −74.190 |

| Elapsed Time | Ground Speed | True Course | Heading | Roll Angle |
|---|---|---|---|---|
| [h:mm:ss.000] | [knots] | [degrees] | [degrees] | [degrees] |
| 0:29:50.440 | 462.22 | 96.74 | 90.53 | 0.00 |
| 0:39:44.242 | 462.26 | 96.79 | 90.58 | 0.00 |
| 0:52:42.307 | 463.11 | 97.76 | 91.56 | 0.00 |
| 1:05:38.739 | 464.21 | 99.01 | 92.83 | 0.00 |
| 1:18:33.348 | 465.29 | 100.25 | 94.09 | 0.00 |
| 1:31:26.170 | 466.36 | 101.47 | 95.34 | 0.00 |
| 1:44:17.242 | 467.41 | 102.66 | 96.56 | 0.00 |
| 1:57:06.608 | 468.43 | 103.84 | 97.77 | 0.00 |
| 2:09:54.310 | 469.43 | 105.00 | 98.96 | 0.00 |
| 2:22:40.393 | 470.41 | 106.13 | 100.12 | 0.00 |
| 2:35:24.907 | 471.36 | 107.23 | 101.26 | 0.00 |
| 2:48:07.898 | 472.29 | 108.31 | 102.37 | 0.00 |
| 2:58:29.447 | 473.19 | 109.36 | 103.46 | 0.00 |
| 2:58:31.669 | 473.26 | 109.44 | 103.55 | −13.66 |
| 2:58:40.077 | 470.55 | 106.29 | 100.28 | −13.66 |
| 2:58:48.549 | 466.21 | 101.30 | 95.16 | −13.66 |
| 2:58:57.101 | 461.84 | 96.31 | 90.09 | −13.66 |
| 2:59:05.733 | 457.47 | 91.32 | 85.07 | −13.66 |
| 2:59:14.449 | 453.12 | 86.33 | 80.09 | −13.66 |
| 2:59:23.247 | 448.85 | 81.34 | 75.16 | −13.66 |
| 2:59:32.129 | 444.67 | 76.36 | 70.28 | −13.66 |
| 2:59:41.094 | 440.62 | 71.37 | 65.44 | −13.66 |
| 2:59:50.140 | 436.72 | 66.38 | 60.65 | −13.66 |
| 2:59:59.265 | 433.00 | 61.39 | 55.90 | −13.66 |
| 3:00:01.580 | 430.77 | 58.27 | 52.95 | −13.66 |
| 3:00:58.333 | 430.40 | 57.73 | 52.45 | 0.00 |
| 3:14:54.725 | 430.44 | 57.79 | 52.51 | 0.00 |
| 3:28:50.440 | 431.10 | 58.73 | 53.39 | 0.00 |
| 3:42:44.849 | 431.79 | 59.71 | 54.31 | 0.00 |
| 3:56:37.886 | 432.52 | 60.73 | 55.28 | 0.00 |
| 4:10:29.481 | 433.29 | 61.79 | 56.28 | 0.00 |
| 4:24:19.563 | 434.10 | 62.89 | 57.33 | 0.00 |
| 4:38:08.060 | 434.95 | 64.04 | 58.42 | 0.00 |
| 4:51:54.899 | 435.84 | 65.22 | 59.55 | 0.00 |
| 5:05:40.007 | 436.77 | 66.45 | 60.72 | 0.00 |
| 5:19:23.310 | 437.75 | 67.72 | 61.94 | 0.00 |
| 5:33:04.735 | 438.77 | 69.04 | 63.20 | 0.00 |
| 5:45:38.162 | 439.84 | 70.39 | 64.50 | 0.00 |

The cruise occurs at constant altitude and speed. The step size in the absence of turns is set at 100 nautical miles. This results in a time between point mass nodes of between 12 and 14 minutes. It only varies because of the wind: there is a turn over DFW which changes the ground speed.

During each step, the most significant thing changing is the weight. At a step size of 100 nautical miles the weight changes less than 1% between point mass nodes. For example, between 800 and 900 miles, the weight changes from 306,478 to 304,355 for a difference of 2,123 pounds which is about 0.7%. The thrust and drag are changing by roughly the same percentage, so that even with the very large steps, the point mass solution is very accurate.

The turn over DFW starts at about 1281 nautical miles range and the range step drops to about 1 nautical mile during the turn. The heading change per step is about 5 degrees which is the target value. The time between point mass nodes drops to about 8 seconds.

The range step size and the target heading change in turns are both user adjustable independent of the desired sample period. The user can make a conscious tradeoff between accuracy and performance.

### Descent

The next three tables show trajectory state data for the descent profile which extends from top of descent to touchdown on landing including the deceleration to descent Mach.

| Elapsed Time | Range | Fuel Burn | Altitude | TAS | IAS | | | Climb Rate |
|---|---|---|---|---|---|---|---|---|
| [h:mm:ss.000] | [nmi] | [lbs] | [ft] | [knots] | [knots] | Mach | Nx | [fpm] |
| 5:45:38.162 | 2491.940 | 60508.6 | 37,000 | 459.04 | 259.79 | 0.8000 | 0.0000 | 0 |
| 5:45:46.284 | 2492.925 | 60511.6 | 37,000 | 450.00 | 254.12 | 0.7842 | −0.0580 | 0 |
| 5:45:48.487 | 2493.188 | 60512.4 | 37,000 | 447.57 | 252.60 | 0.7800 | −0.0578 | 0 |
| 5:46:11.093 | 2495.882 | 60520.8 | 36,000 | 447.75 | 258.52 | 0.7800 | −0.0585 | −2,671 |
| 5:46:31.685 | 2498.340 | 60528.6 | 35,000 | 449.79 | 264.53 | 0.7800 | −0.0593 | −2,941 |
| 5:46:51.867 | 2500.760 | 60536.4 | 34,000 | 451.82 | 270.62 | 0.7800 | −0.0603 | −3,004 |
| 5:47:11.608 | 2503.138 | 60544.2 | 33,000 | 453.84 | 276.79 | 0.7800 | −0.0615 | −3,074 |
| 5:47:30.883 | 2505.471 | 60551.9 | 32,000 | 455.86 | 283.02 | 0.7800 | −0.0627 | −3,151 |
| 5:47:49.672 | 2507.755 | 60559.6 | 31,000 | 457.86 | 289.33 | 0.7800 | −0.0641 | −3,235 |
| 5:47:51.622 | 2507.993 | 60560.4 | 30,895 | 458.07 | 290.00 | 0.7800 | −0.0643 | −3,245 |
| 5:48:16.635 | 2511.023 | 60570.9 | 30,000 | 451.72 | 290.00 | 0.7662 | −0.0599 | −2,131 |
| 5:48:44.905 | 2514.397 | 60582.9 | 29,000 | 444.74 | 290.00 | 0.7511 | −0.0595 | −2,099 |
| 5:49:13.625 | 2517.769 | 60595.4 | 28,000 | 437.88 | 290.00 | 0.7364 | −0.0590 | −2,064 |
| 5:49:42.835 | 2521.144 | 60608.3 | 27,000 | 431.15 | 290.00 | 0.7220 | −0.0585 | −2,029 |
| 5:50:12.551 | 2524.523 | 60621.9 | 26,000 | 424.54 | 290.00 | 0.7079 | −0.0580 | −1,995 |
| 5:50:42.780 | 2527.905 | 60636.5 | 25,000 | 418.05 | 290.00 | 0.6942 | −0.0575 | −1,961 |
| 5:51:13.533 | 2531.290 | 60652.1 | 24,000 | 411.69 | 290.00 | 0.6808 | −0.0571 | −1,928 |
| 5:51:44.818 | 2534.680 | 60668.7 | 23,000 | 405.44 | 290.00 | 0.6677 | −0.0566 | −1,895 |
| 5:52:16.645 | 2538.073 | 60686.5 | 22,000 | 399.30 | 290.00 | 0.6550 | −0.0561 | −1,863 |
| 5:52:49.023 | 2541.471 | 60705.2 | 21,000 | 393.28 | 290.00 | 0.6425 | −0.0557 | −1,832 |
| 5:53:21.964 | 2544.873 | 60725.1 | 20,000 | 387.38 | 290.00 | 0.6303 | −0.0553 | −1,801 |
| 5:53:55.478 | 2548.280 | 60746.0 | 19,000 | 381.58 | 290.00 | 0.6184 | −0.0548 | −1,770 |
| 5:54:29.579 | 2551.692 | 60768.0 | 18,000 | 375.89 | 290.00 | 0.6068 | −0.0544 | −1,739 |
| 5:55:04.280 | 2555.110 | 60791.1 | 17,000 | 370.31 | 290.00 | 0.5955 | −0.0540 | −1,709 |
| 5:55:39.599 | 2558.535 | 60815.4 | 16,000 | 364.83 | 290.00 | 0.5844 | −0.0536 | −1,679 |
| 5:56:15.557 | 2561.967 | 60840.9 | 15,000 | 359.46 | 290.00 | 0.5736 | −0.0531 | −1,649 |
| 5:56:52.182 | 2565.409 | 60867.7 | 14,000 | 354.19 | 290.00 | 0.5630 | −0.0527 | −1,619 |
| 5:57:29.523 | 2568.864 | 60895.8 | 13,000 | 349.02 | 290.00 | 0.5527 | −0.0521 | −1,587 |
| 5:58:07.684 | 2572.340 | 60925.5 | 12,000 | 343.94 | 290.00 | 0.5426 | −0.0514 | −1,550 |
| 5:58:15.134 | 2573.010 | 60929.8 | 11,846 | 340.00 | 287.26 | 0.5361 | −0.0633 | −1,228 |
| 5:58:34.433 | 2574.707 | 60940.7 | 11,462 | 330.00 | 280.23 | 0.5196 | −0.0614 | −1,156 |
| 5:58:54.319 | 2576.400 | 60952.0 | 11,090 | 320.00 | 273.09 | 0.5031 | −0.0596 | −1,088 |
| 5:59:14.797 | 2578.086 | 60963.7 | 10,730 | 310.00 | 265.83 | 0.4868 | −0.0579 | −1,024 |
| 5:59:35.865 | 2579.762 | 60975.8 | 10,381 | 300.00 | 258.46 | 0.4704 | −0.0563 | −964 |
| 5:59:57.509 | 2581.423 | 60988.3 | 10,043 | 290.00 | 250.98 | 0.4542 | −0.0548 | −908 |
| 6:00:00.360 | 2581.637 | 60990.0 | 10,000 | 288.70 | 250.00 | 0.4521 | −0.0546 | −901 |
| 6:00:58.633 | 2585.935 | 61056.9 | 9,306 | 280.00 | 244.89 | 0.4373 | −0.0326 | −703 |
| 6:02:05.687 | 2590.704 | 61132.5 | 8,536 | 270.00 | 238.77 | 0.4205 | −0.0325 | −676 |
| 6:03:12.944 | 2595.299 | 61206.9 | 7,793 | 260.00 | 232.39 | 0.4039 | −0.0324 | −649 |
| 6:04:20.449 | 2599.722 | 61280.5 | 7,078 | 250.00 | 225.76 | 0.3873 | −0.0323 | −622 |
| 6:05:28.233 | 2603.971 | 61353.8 | 6,391 | 240.00 | 218.88 | 0.3709 | −0.0322 | −594 |
| 6:06:36.334 | 2608.049 | 61427.3 | 5,733 | 230.00 | 211.75 | 0.3546 | −0.0320 | −567 |
| 6:07:44.798 | 2611.955 | 61501.8 | 5,102 | 220.00 | 204.39 | 0.3384 | −0.0318 | −539 |
| 6:08:53.686 | 2615.690 | 61578.1 | 4,500 | 210.00 | 196.80 | 0.3224 | −0.0316 | −511 |
| 6:10:03.084 | 2619.255 | 61657.6 | 3,925 | 200.00 | 188.98 | 0.3064 | −0.0314 | −483 |
| 6:11:13.127 | 2622.654 | 61741.8 | 3,378 | 190.00 | 180.95 | 0.2905 | −0.0310 | −454 |
| 6:12:04.566 | 2625.024 | 61807.4 | 3,000 | 182.76 | 175.00 | 0.2791 | −0.0305 | −429 |
| 6:12:25.358 | 2625.952 | 61889.2 | 2,870 | 180.00 | 172.69 | 0.2747 | −0.0274 | −373 |
| 6:13:40.948 | 2629.188 | 62178.8 | 2,414 | 170.00 | 164.17 | 0.2591 | −0.0273 | −351 |
| 6:14:57.128 | 2632.229 | 62460.6 | 1,983 | 160.00 | 155.47 | 0.2435 | −0.0270 | −326 |
| 6:16:12.115 | 2635.008 | 62732.4 | 1,592 | 150.33 | 146.90 | 0.2284 | −0.0264 | −300 |
| 6:16:29.271 | 2635.619 | 62780.1 | 1,400 | 149.91 | 146.90 | 0.2276 | −0.0455 | −671 |
| 6:16:47.192 | 2636.254 | 62830.0 | 1,200 | 149.47 | 146.90 | 0.2268 | −0.0454 | −668 |
| 6:17:05.189 | 2636.889 | 62880.1 | 1,000 | 149.04 | 146.90 | 0.2260 | −0.0454 | −665 |
| 6:17:23.252 | 2637.525 | 62930.5 | 800 | 148.61 | 146.90 | 0.2252 | −0.0453 | −663 |
| 6:17:41.383 | 2638.161 | 62981.1 | 600 | 148.18 | 146.90 | 0.2244 | −0.0453 | −661 |
| 6:17:59.581 | 2638.797 | 63031.9 | 400 | 147.75 | 146.90 | 0.2236 | −0.0452 | −658 |
| 6:18:17.849 | 2639.433 | 63083.0 | 200 | 147.32 | 146.90 | 0.2228 | −0.0452 | −656 |
| 6:18:36.188 | 2640.070 | 63134.4 | 0 | 146.90 | 146.90 | 0.2220 | −0.0451 | −653 |

| Elapsed Time | Weight | Lift | Thrust | Drag | Alpha | Gamma | Latitude | Longitude |
|---|---|---|---|---|---|---|---|---|
| [h:mm:ss.000] | [lbs] | [lbs] | [lbs] | [lbs] | [degrees] | [degrees] | [degrees] | [degrees] |
| 5:45:38.162 | 270,185 | 268,556 | 16,810 | 16,731 | 5.56 | 0.00 | 41.629 | −74.190 |
| 5:45:46.284 | 270,182 | 270,089 | 919 | 16,591 | 5.82 | 0.00 | 41.635 | −74.169 |
| 5:45:48.487 | 270,181 | 270,087 | 919 | 16,540 | 5.88 | 0.00 | 41.636 | −74.164 |
| 5:46:11.093 | 270,173 | 269,609 | 964 | 16,761 | 5.60 | −3.38 | 41.650 | −74.107 |
| 5:46:31.685 | 270,165 | 269,507 | 1,010 | 17,037 | 5.33 | −3.70 | 41.663 | −74.055 |
| 5:46:51.867 | 270,157 | 269,480 | 1,055 | 17,352 | 5.09 | −3.76 | 41.676 | −74.003 |
| 5:47:11.608 | 270,149 | 269,451 | 1,101 | 17,703 | 4.85 | −3.84 | 41.688 | −73.953 |
| 5:47:30.883 | 270,141 | 269,419 | 1,147 | 18,088 | 4.63 | −3.91 | 41.700 | −73.903 |
| 5:47:49.672 | 270,134 | 269,383 | 1,193 | 18,510 | 4.42 | −4.00 | 41.712 | −73.855 |
| 5:47:51.622 | 270,133 | 269,380 | 1,198 | 18,556 | 4.40 | −4.01 | 41.713 | −73.850 |
| 5:48:16.635 | 270,123 | 269,643 | 2,438 | 18,615 | 4.38 | −2.67 | 41.729 | −73.786 |
| 5:48:44.905 | 270,110 | 269,619 | 2,601 | 18,669 | 4.36 | −2.67 | 41.746 | −73.714 |
| 5:49:13.625 | 270,098 | 269,595 | 2,787 | 18,721 | 4.33 | −2.67 | 41.764 | −73.642 |
| 5:49:42.835 | 270,085 | 269,570 | 2,976 | 18,771 | 4.31 | −2.66 | 41.781 | −73.571 |
| 5:50:12.551 | 270,072 | 269,544 | 3,159 | 18,819 | 4.29 | −2.66 | 41.798 | −73.499 |
| 5:50:42.780 | 270,057 | 269,519 | 3,338 | 18,866 | 4.27 | −2.66 | 41.816 | −73.427 |
| 5:51:13.533 | 270,041 | 269,492 | 3,512 | 18,912 | 4.25 | −2.65 | 41.833 | −73.355 |
| 5:51:44.818 | 270,025 | 269,465 | 3,682 | 18,956 | 4.23 | −2.65 | 41.850 | −73.282 |
| 5:52:16.645 | 270,007 | 269,437 | 3,848 | 18,998 | 4.21 | −2.64 | 41.867 | −73.210 |
| 5:52:49.023 | 269,988 | 269,409 | 4,010 | 19,039 | 4.20 | −2.64 | 41.884 | −73.138 |
| 5:53:21.964 | 269,968 | 269,380 | 4,169 | 19,078 | 4.18 | −2.63 | 41.902 | −73.065 |
| 5:53:55.478 | 269,947 | 269,350 | 4,324 | 19,116 | 4.16 | −2.63 | 41.919 | −72.992 |
| 5:54:29.579 | 269,925 | 269,319 | 4,477 | 19,152 | 4.15 | −2.62 | 41.936 | −72.919 |
| 5:55:04.280 | 269,902 | 269,288 | 4,629 | 19,187 | 4.14 | −2.61 | 41.953 | −72.846 |
| 5:55:39.599 | 269,878 | 269,255 | 4,780 | 19,221 | 4.12 | −2.61 | 41.970 | −72.773 |
| 5:56:15.557 | 269,852 | 269,222 | 4,933 | 19,254 | 4.11 | −2.60 | 41.987 | −72.700 |
| 5:56:52.182 | 269,826 | 269,187 | 5,091 | 19,285 | 4.10 | −2.59 | 42.004 | −72.626 |
| 5:57:29.523 | 269,798 | 269,151 | 5,264 | 19,315 | 4.08 | −2.57 | 42.021 | −72.552 |
| 5:58:07.684 | 269,768 | 269,111 | 5,482 | 19,344 | 4.07 | −2.55 | 42.038 | −72.477 |
| 5:58:15.134 | 269,764 | 269,440 | 2,099 | 19,156 | 4.15 | −2.04 | 42.042 | −72.463 |
| 5:58:34.433 | 269,753 | 269,430 | 2,117 | 18,665 | 4.35 | −1.98 | 42.050 | −72.427 |
| 5:58:54.319 | 269,741 | 269,419 | 2,135 | 18,197 | 4.57 | −1.92 | 42.058 | −72.390 |
| 5:59:14.797 | 269,730 | 269,405 | 2,153 | 17,754 | 4.82 | −1.87 | 42.067 | −72.354 |
| 5:59:35.865 | 269,718 | 269,389 | 2,170 | 17,342 | 5.09 | −1.82 | 42.075 | −72.318 |
| 5:59:57.509 | 269,705 | 269,371 | 2,186 | 16,965 | 5.39 | −1.77 | 42.083 | −72.283 |
| 6:00:00.360 | 269,703 | 269,368 | 2,192 | 16,919 | 5.43 | −1.77 | 42.084 | −72.278 |
| 6:00:58.633 | 269,636 | 268,777 | 7,912 | 16,672 | 5.64 | −1.42 | 42.105 | −72.186 |
| 6:02:05.687 | 269,561 | 268,685 | 7,696 | 16,429 | 5.92 | −1.42 | 42.128 | −72.083 |
| 6:03:12.944 | 269,487 | 268,589 | 7,514 | 16,210 | 6.23 | −1.41 | 42.150 | −71.984 |
| 6:04:20.449 | 269,413 | 268,486 | 7,368 | 16,023 | 6.59 | −1.41 | 42.172 | −71.889 |
| 6:05:28.233 | 269,340 | 268,373 | 7,270 | 15,880 | 7.00 | −1.40 | 42.192 | −71.798 |
| 6:06:36.334 | 269,266 | 268,247 | 7,232 | 15,789 | 7.47 | −1.39 | 42.212 | −71.710 |
| 6:07:44.798 | 269,192 | 268,101 | 7,268 | 15,764 | 8.00 | −1.39 | 42.230 | −71.626 |
| 6:08:53.686 | 269,115 | 267,929 | 7,397 | 15,821 | 8.62 | −1.38 | 42.248 | −71.545 |
| 6:10:03.084 | 269,036 | 267,721 | 7,641 | 15,976 | 9.33 | −1.37 | 42.265 | −71.468 |
| 6:11:13.127 | 268,952 | 267,460 | 8,033 | 16,252 | 10.16 | −1.35 | 42.281 | −71.395 |
| 6:12:04.566 | 268,886 | 267,216 | 8,488 | 16,542 | 10.85 | −1.33 | 42.292 | −71.343 |
| 6:12:25.358 | 268,804 | 263,937 | 25,211 | 32,115 | 11.00 | −1.17 | 42.297 | −71.323 |
| 6:13:40.948 | 268,515 | 263,405 | 24,025 | 30,827 | 12.14 | −1.17 | 42.312 | −71.253 |
| 6:14:57.128 | 268,233 | 262,767 | 23,181 | 29,776 | 13.50 | −1.15 | 42.326 | −71.188 |
| 6:16:12.115 | 267,961 | 261,995 | 22,742 | 29,030 | 15.07 | −1.13 | 42.339 | −71.127 |
| 6:16:29.271 | 267,913 | 263,069 | 17,553 | 29,132 | 15.13 | −2.53 | 42.342 | −71.114 |
| 6:16:47.192 | 267,863 | 263,015 | 17,575 | 29,127 | 15.13 | −2.53 | 42.345 | −71.101 |
| 6:17:05.189 | 267,813 | 262,964 | 17,585 | 29,123 | 15.13 | −2.53 | 42.348 | −71.087 |
| 6:17:23.252 | 267,763 | 262,913 | 17,595 | 29,118 | 15.12 | −2.53 | 42.351 | −71.073 |
| 6:17:41.383 | 267,712 | 262,862 | 17,605 | 29,114 | 15.12 | −2.52 | 42.354 | −71.059 |
| 6:17:59.581 | 267,661 | 262,810 | 17,616 | 29,109 | 15.11 | −2.52 | 42.357 | −71.045 |
| 6:18:17.849 | 267,610 | 262,757 | 17,627 | 29,105 | 15.11 | −2.52 | 42.360 | −71.032 |
| 6:18:36.188 | 267,559 | 262,705 | 17,641 | 29,100 | 15.10 | −2.52 | 42.363 | −71.018 |

| Elapsed Time | Ground Speed | True Course | Heading | Roll Angle |
|---|---|---|---|---|
| [h:mm:ss.000] | [knots] | [degrees] | [degrees] | [degrees] |
| 5:45:38.162 | 439.84 | 70.39 | 64.50 | 0.00 |
| 5:45:46.284 | 431.76 | 71.66 | 65.61 | 0.00 |
| 5:45:48.487 | 429.33 | 71.68 | 65.59 | 0.00 |
| 5:46:11.093 | 428.73 | 71.68 | 65.59 | 0.00 |
| 5:46:31.685 | 430.65 | 71.72 | 65.65 | 0.00 |
| 5:46:51.867 | 432.68 | 71.75 | 65.71 | 0.00 |
| 5:47:11.608 | 434.70 | 71.79 | 65.77 | 0.00 |
| 5:47:30.883 | 436.71 | 71.82 | 65.83 | 0.00 |
| 5:47:49.672 | 438.70 | 71.85 | 65.88 | 0.00 |
| 5:47:51.622 | 438.93 | 71.89 | 65.92 | 0.00 |
| 5:48:16.635 | 433.18 | 71.89 | 65.84 | 0.00 |
| 5:48:44.905 | 426.20 | 71.93 | 65.79 | 0.00 |
| 5:49:13.625 | 419.35 | 71.98 | 65.74 | 0.00 |
| 5:49:42.835 | 412.62 | 72.03 | 65.69 | 0.00 |
| 5:50:12.551 | 406.02 | 72.08 | 65.64 | 0.00 |
| 5:50:42.780 | 399.54 | 72.12 | 65.58 | 0.00 |
| 5:51:13.533 | 393.17 | 72.17 | 65.53 | 0.00 |
| 5:51:44.818 | 386.93 | 72.22 | 65.47 | 0.00 |
| 5:52:16.645 | 380.80 | 72.27 | 65.41 | 0.00 |
| 5:52:49.023 | 374.78 | 72.32 | 65.35 | 0.00 |
| 5:53:21.964 | 368.87 | 72.37 | 65.29 | 0.00 |
| 5:53:55.478 | 363.08 | 72.41 | 65.23 | 0.00 |
| 5:54:29.579 | 357.39 | 72.46 | 65.17 | 0.00 |
| 5:55:04.280 | 351.81 | 72.51 | 65.10 | 0.00 |
| 5:55:39.599 | 346.34 | 72.56 | 65.04 | 0.00 |
| 5:56:15.557 | 340.96 | 72.61 | 64.97 | 0.00 |
| 5:56:52.182 | 335.69 | 72.66 | 64.91 | 0.00 |
| 5:57:29.523 | 330.52 | 72.71 | 64.84 | 0.00 |
| 5:58:07.684 | 325.45 | 72.76 | 64.77 | 0.00 |
| 5:58:15.134 | 321.63 | 72.81 | 64.73 | 0.00 |
| 5:58:34.433 | 311.55 | 72.82 | 64.49 | 0.00 |
| 5:58:54.319 | 301.48 | 72.84 | 64.25 | 0.00 |
| 5:59:14.797 | 291.40 | 72.86 | 63.99 | 0.00 |
| 5:59:35.865 | 281.31 | 72.89 | 63.72 | 0.00 |
| 5:59:57.509 | 271.20 | 72.91 | 63.42 | 0.00 |
| 6:00:00.360 | 269.91 | 72.94 | 63.40 | 0.00 |
| 6:00:58.633 | 261.13 | 72.94 | 63.11 | 0.00 |
| 6:02:05.687 | 251.03 | 73.00 | 62.80 | 0.00 |
| 6:03:12.944 | 240.92 | 73.07 | 62.47 | 0.00 |
| 6:04:20.449 | 230.80 | 73.14 | 62.10 | 0.00 |
| 6:05:28.233 | 220.65 | 73.20 | 61.69 | 0.00 |
| 6:06:36.334 | 210.49 | 73.26 | 61.24 | 0.00 |
| 6:07:44.798 | 200.31 | 73.32 | 60.74 | 0.00 |
| 6:08:53.686 | 190.10 | 73.38 | 60.19 | 0.00 |
| 6:10:03.084 | 179.86 | 73.43 | 59.56 | 0.00 |
| 6:11:13.127 | 169.58 | 73.48 | 58.87 | 0.00 |
| 6:12:04.566 | 162.13 | 73.53 | 58.32 | 0.00 |
| 6:12:25.358 | 159.31 | 73.57 | 58.11 | 0.00 |
| 6:13:40.948 | 148.92 | 73.58 | 57.19 | 0.00 |
| 6:14:57.128 | 138.51 | 73.63 | 56.18 | 0.00 |
| 6:16:12.115 | 128.38 | 73.67 | 55.05 | 0.00 |
| 6:16:29.271 | 127.84 | 73.71 | 55.02 | 0.00 |
| 6:16:47.192 | 127.39 | 73.72 | 54.97 | 0.00 |
| 6:17:05.189 | 126.94 | 73.73 | 54.93 | 0.00 |
| 6:17:23.252 | 126.49 | 73.74 | 54.88 | 0.00 |
| 6:17:41.383 | 126.04 | 73.75 | 54.83 | 0.00 |
| 6:17:59.581 | 125.60 | 73.76 | 54.78 | 0.00 |
| 6:18:17.849 | 125.16 | 73.77 | 54.73 | 0.00 |
| 6:18:36.188 | 124.72 | 73.78 | 54.68 | 0.00 |

The first vertical segment in the descent is a deceleration in level flight from Mach 0.8 to 0.78 at idle thrust. The next segment is an idle thrust descent at constant Mach down to transition altitude of 30,895 feet resulting in a relatively large sink rate of about 3,000 fpm.

The next segment is a controlled throttle constant indicated airspeed segment down to 12,000 feet. The throttle is adjusted at each point mass node to achieve the 12,000 foot altitude at a specified range: 2572.413 nautical miles. This amounts to controlling thrust for a fixed angle of descent with respect to the ground. This includes the effect of the wind. The range is not guaranteed: the actual range at 12,000 feet is 2572.340 nautical miles, an error of 0.073 nautical miles.

The target range was selected by estimating the descent range using energy methods assuming no wind and multiplying by a conservative factor of 1.3. The conservative factor is so that in the event of a tail wind and zero throttle, the flight will be able to get down by the desired range. This conservative descent range is then subtracted from the known route range and used to specify the top of descent range.

The next segment is an idle thrust energy trade down to 10,000 feet and 250 knots. The flight path angle shallows out because kinetic energy is being converted to potential energy. An energy trade segment specifies a change in altitude that is proportional to the change in energy for each velocity step. That is:

$$Δ h = k \cdot Δ ( \frac{{V}^{2}}{2 g} ) = k \cdot \frac{\overline{V} Δ V}{g} \qquad ( 36 )$$

The next segment is a controlled throttle energy trade down to 3,000 feet, 175 knots, at a range 5 nautical miles from the final approach fix. It can be shown that an energy trade flown at constant flight path angle results in constant deceleration, constant nₓ, and approximately constant throttle. Looking at the data, while the angle of attack varies from 5.64 to 10.85, the flight path angle only varies from −1.42 to −1.35, and nₓ only varies from −0.0326 to −0.0305. This is all accomplished in a 50 knot quartering head wind.

The next segment is another controlled throttle energy trade flown in the dirty configuration (gear down, landing flaps) down to the final approach fix which is defined as 5 nautical miles at a 3 degrees flight path angle from the threshold. The thrust jumps from 8,488 pounds to 25,211 pounds reflecting the large increase in drag. This corresponds to about 30% of the available thrust.

The final approach is a controlled throttle constant indicated airspeed segment to zero altitude and the runway threshold. The angle of attack and flight path angle are approximately constant despite the wind. The aircraft lands at 146.9 knots which is the approach speed: 1.3 times the landing stall speed of 113 knots. The ground speed is only 124.72 knots because of the head wind.

The step size has been reduced for the final approach from 1000 feet to 200 feet. This improves the accuracy with respect to the wind for this relatively short segment.

### Landing and Taxi in

The next three tables show trajectory state data for the landing ground roll and taxi in.

| Elapsed Time | Range | Fuel Burn | Altitude | TAS | IAS | | | Climb Rate |
|---|---|---|---|---|---|---|---|---|
| [h:mm:ss.000] | [nmi] | [lbs] | [ft] | [knots] | [knots] | Mach | Nx | [fpm] |
| 6:18:36.188 | 2640.070 | 63134.4 | 0 | 146.90 | 146.90 | 0.2220 | −0.0451 | −653 |
| 6:18:37.156 | 2640.103 | 63135.0 | 0 | 142.30 | 142.30 | 0.2150 | −0.2468 | 0 |
| 6:18:39.178 | 2640.167 | 63136.3 | 0 | 132.93 | 132.93 | 0.2009 | −0.2393 | 0 |
| 6:18:41.240 | 2640.227 | 63137.7 | 0 | 123.66 | 123.66 | 0.1869 | −0.2323 | 0 |
| 6:18:43.334 | 2640.283 | 63139.1 | 0 | 114.51 | 114.51 | 0.1730 | −0.2259 | 0 |
| 6:18:45.450 | 2640.333 | 63140.4 | 0 | 105.51 | 105.51 | 0.1595 | −0.2200 | 0 |
| 6:18:47.572 | 2640.377 | 63141.8 | 0 | 96.72 | 96.72 | 0.1462 | −0.2148 | 0 |
| 6:18:49.680 | 2640.415 | 63143.2 | 0 | 88.18 | 88.18 | 0.1332 | −0.2101 | 0 |
| 6:18:51.747 | 2640.447 | 63144.6 | 0 | 79.97 | 79.97 | 0.1209 | −0.2060 | 0 |
| 6:18:53.736 | 2640.471 | 63145.9 | 0 | 72.23 | 72.23 | 0.1091 | −0.2025 | 0 |
| 6:18:55.596 | 2640.490 | 63147.1 | 0 | 65.09 | 65.09 | 0.0984 | −0.1996 | 0 |
| 6:18:56.853 | 2640.500 | 63150.6 | 0 | 65.09 | 65.09 | 0.0984 | 0.0000 | 0 |
| 6:19:08.853 | 2640.600 | 63184.1 | 0 | 65.09 | 65.09 | 0.0984 | 0.0000 | 0 |
| 6:19:20.853 | 2640.700 | 63217.6 | 0 | 65.09 | 65.09 | 0.0984 | 0.0000 | 0 |
| 6:19:32.853 | 2640.800 | 63251.1 | 0 | 65.09 | 65.09 | 0.0984 | 0.0000 | 0 |
| 6:19:44.265 | 2640.895 | 63282.9 | 0 | 65.09 | 65.09 | 0.0984 | 0.0000 | 0 |
| 6:19:47.201 | 2640.900 | 63290.5 | 0 | 48.67 | 48.67 | 0.0735 | 0.0000 | 0 |
| 6:20:47.201 | 2641.000 | 63444.8 | 0 | 48.67 | 48.67 | 0.0735 | 0.0000 | 0 |
| 6:21:47.201 | 2641.100 | 63599.2 | 0 | 48.67 | 48.67 | 0.0735 | 0.0000 | 0 |
| 6:22:47.201 | 2641.200 | 63753.4 | 0 | 48.67 | 48.67 | 0.0735 | 0.0000 | 0 |
| 6:23:47.201 | 2641.300 | 63907.6 | 0 | 48.67 | 48.67 | 0.0735 | 0.0000 | 0 |
| 6:24:44.265 | 2641.395 | 64054.1 | 0 | 48.67 | 48.67 | 0.0735 | 0.0000 | 0 |

| Elapsed Time | Weight | Lift | Thrust | Drag | Alpha | Gamma | Latitude | Longitude |
|---|---|---|---|---|---|---|---|---|
| [h:mm:ss.000] | [lbs] | [lbs] | [lbs] | [lbs] | [degrees] | [degrees] | [degrees] | [degrees] |
| 6:18:36.188 | 267,559 | 262,705 | 17,641 | 29,100 | 15.10 | −2.52 | 42.363 | −71.018 |
| 6:18:37.156 | 267,558 | 0 | 3,145 | 15,680 | 0.00 | 0.00 | 42.363 | −71.017 |
| 6:18:39.178 | 267,557 | 0 | 3,175 | 13,683 | 0.00 | 0.00 | 42.363 | −71.016 |
| 6:18:41.240 | 267,556 | 0 | 3,206 | 11,841 | 0.00 | 0.00 | 42.364 | −71.014 |
| 6:18:43.334 | 267,554 | 0 | 3,235 | 10,153 | 0.00 | 0.00 | 42.364 | −71.013 |
| 6:18:45.450 | 267,553 | 0 | 3,265 | 8,621 | 0.00 | 0.00 | 42.364 | −71.012 |
| 6:18:47.572 | 267,552 | 0 | 3,293 | 7,243 | 0.00 | 0.00 | 42.364 | −71.011 |
| 6:18:49.680 | 267,550 | 0 | 3,321 | 6,020 | 0.00 | 0.00 | 42.364 | −71.010 |
| 6:18:51.747 | 267,549 | 0 | 3,348 | 4,952 | 0.00 | 0.00 | 42.365 | −71.010 |
| 6:18:53.736 | 267,547 | 0 | 3,374 | 4,039 | 0.00 | 0.00 | 42.365 | −71.009 |
| 6:18:55.596 | 267,546 | 0 | 3,397 | 3,281 | 0.00 | 0.00 | 42.365 | −71.009 |
| 6:18:56.853 | 267,543 | 0 | 16,658 | 3,281 | 0.00 | 0.00 | 42.365 | −71.009 |
| 6:19:08.853 | 267,509 | 0 | 16,658 | 3,281 | 0.00 | 0.00 | 42.365 | −71.006 |
| 6:19:20.853 | 267,476 | 0 | 16,656 | 3,281 | 0.00 | 0.00 | 42.366 | −71.004 |
| 6:19:32.853 | 267,442 | 0 | 16,655 | 3,281 | 0.00 | 0.00 | 42.366 | −71.002 |
| 6:19:44.265 | 267,410 | 0 | 16,653 | 3,281 | 0.00 | 0.00 | 42.367 | −71.000 |
| 6:19:47.201 | 267,403 | 0 | 15,205 | 1,834 | 0.00 | 0.00 | 42.367 | −71.000 |
| 6:20:47.201 | 267,249 | 0 | 15,204 | 1,834 | 0.00 | 0.00 | 42.366 | −71.002 |
| 6:21:47.201 | 267,094 | 0 | 15,196 | 1,834 | 0.00 | 0.00 | 42.366 | −71.004 |
| 6:22:47.201 | 266,940 | 0 | 15,189 | 1,834 | 0.00 | 0.00 | 42.365 | −71.007 |
| 6:23:47.201 | 266,786 | 0 | 15,181 | 1,834 | 0.00 | 0.00 | 42.365 | −71.009 |
| 6:24:44.265 | 266,639 | 0 | 15,173 | 1,834 | 0.00 | 0.00 | 42.364 | −71.011 |

| Elapsed Time | Ground Speed | True Course | Heading | Roll Angle |
|---|---|---|---|---|
| [h:mm:ss.000] | [knots] | [degrees] | [degrees] | [degrees] |
| 6:18:36.188 | 124.72 | 73.78 | 54.68 | 0.00 |
| 6:18:37.156 | 120.00 | 73.79 | 73.79 | 0.00 |
| 6:18:39.178 | 110.00 | 73.79 | 73.79 | 0.00 |
| 6:18:41.240 | 100.00 | 73.79 | 73.79 | 0.00 |
| 6:18:43.334 | 90.00 | 73.79 | 73.79 | 0.00 |
| 6:18:45.450 | 80.00 | 73.79 | 73.79 | 0.00 |
| 6:18:47.572 | 70.00 | 73.79 | 73.79 | 0.00 |
| 6:18:49.680 | 60.00 | 73.79 | 73.79 | 0.00 |
| 6:18:51.747 | 50.00 | 73.79 | 73.79 | 0.00 |
| 6:18:53.736 | 40.00 | 73.79 | 73.79 | 0.00 |
| 6:18:55.596 | 30.00 | 73.79 | 73.79 | 0.00 |
| 6:18:56.853 | 30.00 | 73.79 | 73.79 | 0.00 |
| 6:19:08.853 | 30.00 | 73.79 | 73.79 | 0.00 |
| 6:19:20.853 | 30.00 | 73.79 | 73.79 | 0.00 |
| 6:19:32.853 | 30.00 | 73.80 | 73.80 | 0.00 |
| 6:19:44.265 | 30.00 | 73.80 | 73.80 | 0.00 |
| 6:19:47.201 | 6.00 | 253.80 | 253.80 | 0.00 |
| 6:20:47.201 | 6.00 | 253.80 | 253.80 | 0.00 |
| 6:21:47.201 | 6.00 | 253.80 | 253.80 | 0.00 |
| 6:22:47.201 | 6.00 | 253.80 | 253.80 | 0.00 |
| 6:23:47.201 | 6.00 | 253.79 | 253.79 | 0.00 |
| 6:24:44.265 | 6.00 | 253.79 | 253.79 | 0.00 |

The first landing segment is the ground roll down to 30 knots which is the high speed taxi speed. The braking coefficient of friction is 0.20, which is consistent with nₓ varying from −0.2468 down to −0.1996. The magnitude of the last value is less than 0.2 because idle thrust is not zero and at the end of the ground roll, the idle thrust (3,397 pounds) is greater than the drag (3,281 pounds). The braking gear reaction is not included in the drag and is on the order of 53,510 pounds (20% of 267,550 pounds).

The second landing segment is the high speed taxi at 30 knots. Taxi segments occur at constant speed and the integration variable is range (like cruise). The wind is accounted for in the drag. This is why the indicated airspeed during the high speed taxi is about 65 knots. The cross wind component is ignored.

Note that the end of the high speed taxi is 42.367, −71.000 which corresponds to KBOS=42:22:00/−71:00:00.

The last segment is a 6 knot taxi for 0.5 nautical miles designed to use up 5 minutes. Both taxi segments account for rolling coefficient of friction of 0.02 (see Balkwill, K. J.: Development of a Comprehensive Method for Modelling Performance of Aircraft Tyres Rolling or Braking on Dry and Precipitation Contaminated Runways. ESDU International report TP 14289E, May 2003).

While the present invention has been particularly shown and described with reference to the preferred mode as illustrated in the drawings, it will be understood by one skilled in the art that various changes in detail may be effected therein without departing from the spirit and scope of the invention as defined by the claims.

We claim:

1. A method of simulating the flight path trajectory of an aircraft between two fixed points including operating at least an aerodynamic model, a propulsion model for said aircraft type and a program including point mass equations on one or more linked computers, said method comprising the steps of:
defining said two fixed points as a point of origin and a destination, respectively;
defining a plurality of waypoints and a plurality of altitude-velocity segments between said two fixed points;
defining a time of takeoff, an aircraft empty weight and gross weight at said point of origin; wherein said aerodynamic model and said propulsion model determine performance characteristics of said aircraft;
determining said aircraft flight path trajectory using said program including point mass equations, wherein said program including point mass equations further comprising the step of separating said aircraft flight path trajectory into a horizontal profile and a vertical profile for said aircraft;
selecting a non-time based integration variable and a step size for said non-time based integration variable for each altitude-velocity segment of said vertical profile;
integrating said horizontal profile and said vertical profile of said aircraft flight path trajectory iteratively at least at each node along said flight path trajectory using said program including point mass equations and said non-time based integration variable selected for each altitude-velocity segment of said vertical profile.

2. The method of simulating the flight path trajectory of an aircraft of claim 1, further comprising the step of determining environmental conditions along said flight path trajectory.

3. The method of simulating the flight path trajectory of an aircraft of claim 1, further comprising the step of displaying said simulated flight path trajectory to a user on a monitor.

4. The method of simulating the flight path trajectory of an aircraft of claim 1, wherein said aircraft performance characteristics includes at least aircraft weight, lift, drag, engine fuel burn and thrust characteristics of said aircraft.

5. The method of simulating the flight path trajectory of an aircraft of claim 4, wherein said aircraft performance characteristics further includes at least one of climb speed, descent speed, cruise speed, payload and fuel load for said aircraft.

6. The method of simulating the flight path trajectory of an aircraft of claim 2, wherein said environmental conditions includes at least one of winds aloft and temperatures along said flight path trajectory.

7. The method of simulating the flight path trajectory of an aircraft of claim 1, wherein said waypoints are geographic locations defined by a latitude-longitude pair.

8. The method of simulating the flight path trajectory of an aircraft of claim 7, wherein said waypoints are connected to each other using a combination of great circle arcs and small circle arcs along said flight path.

9. The method of simulating the flight path trajectory of an aircraft of claim 1, said vertical profile comprising altitude-velocity segments including at least a starting node and an ending node along said aircraft flight path trajectory and an altitude-velocity segment type.

10. The method of simulating the flight path trajectory of an aircraft of claim 9, wherein said altitude-velocity segments further include at least one acceleration, deceleration or cruise of said aircraft.

11. The method of simulating the flight path trajectory of an aircraft of claim 1, wherein said non-time based integration step size varies based on aircraft maneuvers.

12. The method of simulating the flight path trajectory of an aircraft of claim 1, wherein said non-time based integration variable is one of altitude, velocity, range, or flight path angle for each altitude-velocity segment.

13. The method of simulating the flight path trajectory of an aircraft of claim 12, wherein said non-time based integration variable includes time for aircraft loiter.

14. The method of simulating the flight path trajectory of an aircraft of claim 12, wherein said non-time based integration variable is altitude during the climb and descent phases of flight and said non-time based integration variable is range during en route phase of flight.

15. The method of simulating the flight path trajectory of an aircraft of claim 12, wherein said non-time based integration variable is velocity during the climb and descent phases of flight and said non-time based integration variable is range during en route phase of flight.

16. The method of simulating the flight path trajectory of an aircraft of claim 12, wherein a different non-time based integration variable is used to integrate one or more altitude-velocity segments of said flight path trajectory.

17. The method of simulating the flight path trajectory of an aircraft of claim 1, further comprising the steps of:
receiving a change to said flight path trajectory;
determining a new flight path trajectory using said program including point mass equations and said non-time based integration variable selected for each altitude-velocity segment of said vertical profile, and
integrating said horizontal profile and said vertical profile iteratively at points along said new flight path trajectory using said program including point mass equations and said non-time based integration variable selected for each altitude-velocity segment of said vertical profile.

18. The method of simulating the flight path trajectory of an aircraft of claim 17, wherein said non-time based integration step size varies based on aircraft maneuvers.

19. The method of simulating the flight path trajectory of an aircraft of claim 1, further comprising the step storing said simulated flight path trajectory of said aircraft on a computer readable medium

20. The method of simulating the flight path trajectory of an aircraft of claim 19, further comprising the step of validating the stored simulated aircraft flight path trajectory with actual flight path trajectory data for said aircraft.

21. A system for simulating the flight path trajectory of an aircraft, including at least one computer, said system comprising:
means for defining a point of origin and a destination, a time of takeoff, aircraft empty weight and gross weight at a point of origin, and a plurality of waypoints and a plurality of altitude-velocity segments between said point of origin and said destination;
means for determining performance characteristics of said aircraft;
means for determining said aircraft flight path trajectory, wherein said means for determining said aircraft flight path trajectory separates said flight path trajectory into a horizontal profile and a vertical profile for said aircraft flight path trajectory;
means for selecting an appropriate non-time based integration variable and an integration variable step size for each of said plurality of altitude-velocity segments in said vertical profile;
means for integrating said horizontal profile and said vertical profile for said aircraft flight path trajectory iteratively at least at each node along said flight path trajectory using said non-time based integration variables.

22. The system for simulating the flight path trajectory of an aircraft of claim 21, further comprising means for determining environmental conditions along the flight path trajectory.

23. The system for simulating the flight path trajectory of an aircraft of claim 21, further comprising means for displaying the simulated flight path trajectory to a user on a monitor.

24. The system for simulating the flight path trajectory of an aircraft of claim 21, wherein said means for determining said flight path trajectory comprises a program on computer readable medium.

25. The system for simulating the flight path trajectory of an aircraft of claim 21, said aircraft performance characteristics comprising aircraft weight, lift, drag, engine fuel burn and thrust characteristics of said aircraft.

26. The system for simulating the flight path trajectory of an aircraft of claim 25, wherein said aircraft performance characteristics further comprise at least one of climb speed, descent speed, cruise speed, payload and fuel load for said aircraft.

27. The system for simulating the flight path trajectory of an aircraft of claim 22, wherein said environmental conditions comprise at least one of winds aloft and temperatures along said flight path trajectory.

28. The system for simulating the flight path trajectory of an aircraft of claim 21, wherein said waypoints are geographic locations defined by a latitude-longitude pair.

29. The system for simulating the flight path trajectory of an aircraft of claim 21, said waypoints are connected to each other using a combination of great circle arcs and small circle arcs along said flight path.

30. The system for simulating the flight path trajectory of an aircraft of claim 21, said vertical profile comprising altitude-velocity segments including at least a starting node and an ending node along said aircraft flight path trajectory and an altitude-velocity segment type.

31. The system for simulating the flight path trajectory of an aircraft of claim 30, said altitude-velocity segments further comprising at least one acceleration, deceleration or cruise of said aircraft.

32. The system for simulating the flight path trajectory of an aircraft of claim 21, wherein said non-time based integration step size varies based on aircraft maneuvers.

33. The system for simulating the flight path trajectory of an aircraft of claim 21, wherein said integration variable step size is based on the desired accuracy for said altitude-velocity segment.

34. The system for simulating the flight path trajectory of an aircraft of claim 21, wherein said non-time based integration variable is one of altitude, velocity, range, or flight path angle for each altitude-velocity segment.

35. The method of simulating the flight path trajectory of an aircraft of claim 34, wherein said non-time based integration variable includes time for aircraft loiter.

36. The system for simulating the flight path trajectory of an aircraft of claim 34, wherein said non-time based integration variable is altitude for said altitude-velocity segments during the climb and descent phases of flight and said non-time based integration variable is range for said altitude-velocity segments during en route cruise phase of flight.

37. The system for simulating the flight path trajectory of an aircraft of claim 34, wherein said non-time based integration variable is velocity for said altitude-velocity segments during the climb and descent phases of flight and said non-time based integration variable is range for said altitude-velocity segments during en route cruise phase of flight.

38. The system for simulating the flight path trajectory of an aircraft of claim 34, wherein a different integration variable is used to integrate one or more altitude-velocity segments of said flight path trajectory.

39. The system for simulating the flight path trajectory of an aircraft of claim 21, further comprising:
means for receiving a change to said flight path trajectory;
means for determining a new flight path trajectory, and
means for integrating said horizontal profile and said vertical profile iteratively at points along said new flight path trajectory.

40. The system for simulating the flight path trajectory of an aircraft of claim 39, wherein said non-time based integration step size varies based on aircraft maneuvers.

41. The system for simulating the flight path trajectory of an aircraft of claim 39, wherein said integration variable step size is based on the desired accuracy for the altitude-velocity segment.

42. The system for simulating the flight path trajectory of an aircraft of claim 39, further comprising means for displaying said simulated flight path trajectory on a monitor for a user to view.

43. The system for simulating the flight path trajectory of an aircraft of claim 21, where said simulated flight path is stored on a computer readable medium.

44. The system for simulating the flight path trajectory of an aircraft of claim 43, further comprising means for validating the simulated aircraft flight path trajectory stored on a computer readable medium against actual flight path trajectory data.
